(19) United States
(12) Patent Application Publication
(10) Pub. No.: US 2025/0188196 A1
(43) Pub. Date: Jun. 12, 2025

(54) COMPOSITIONS AND METHODS RELATED FUNCTIONALIZED CELLULOSE NANOFIBRILS

(71) Applicant: The Regents of the University of California, Oakland, CA (US)

(72) Inventors: You-Lo HSIEH, Davis, CA (US); Mengzhe GUO, Davis, CA (US)

(21) Appl. No.: 18/846,631

(22) PCT Filed: Mar. 17, 2023
(86) PCT No.: PCT/US2023/015468

§ 371 Date: Sep. 12, 2024

Related U.S. Application Data
(60) Provisional application No. 63/321,033, filed on Mar. 17, 2022.

(51) Int. Cl. C08B 3/22; C08B 1/00; C08F 4/10; C08F 251/02; C08G 18/10; C08G 18/32; C08G 18/48; C08G 18/64

(52) U.S. Cl. CPC C08B 3/22; C08B 1/003; C08F 4/10; C08F 251/02; C08G 18/10; C08G 18/3206; C08G 18/4854; C08G 18/6484; C08F 2438/01

(57) ABSTRACT

The present disclosure provides compositions and methods relating to hydrophobic esterified nanocellulose.

### CROSS-REFERENCE TO RELATED APPLICATIONS

The present application claims priority to U.S. Provisional Application No. 63/321,033, filed on Mar. 17, 2022, the disclosure of which is incorporated herein by reference in its entirety for all purposes.

### BACKGROUND

Cellulose is not only the most abundant natural polymer on earth with renewable annual production of 75 to 100 billion tons,¹ but also the most chemically homogeneous and intrinsically semi-crystalline. The crystalline domains can be isolated as a few to tens nm wide and hundreds nm long rod-like cellulose nanocrystals (CNCs) or thinner and longer cellulose nanofibrils (CNFs). These so called nanocelluloses have gained increasing attention due to their ultra-high elastic modulus (150 GPa for CNCs, 28 GPa for CNFs)^{2, 3}, low axial thermal expansion coefficient (10⁻⁷ K⁻¹ for CNCs, 5×10⁻⁶ K⁻¹ for CNFs)^{4, 5} and biocompatibility^{6, 7}. CNCs and CNFs have been most commonly produced by removing the non-crystalline regions via acid hydrolysis⁸⁻¹², modifying them by oxidation¹²⁻¹⁸, disintegration via mechanical forces^{12-17, 19-22} or a combination of the latter two¹³⁻¹⁷. These nanocelluloses⁸⁻²² are all hydrophilic, some with anionic charges, making them easily dispersible in aqueous media, but incompatible with less polar and non-polar organic liquids and most synthetic polymers.

To render these hydrophilic nanocelluloses to be more compatible with organic media and polymers for broader applications, various physical or chemical means have been explored²³⁻³¹ and reviewed³². CNCs were freeze-dried then ultmsonicated²³⁻²⁵ and CNFs were acetone exchanged then homogenized²⁶ to be dispersible in DMF. Chemical reactions, such as estcrification²⁷, acctylation^{28, 29}, silanation³⁰, and amidation³¹ have also been applied to convert the hydrophilic hydroxyls²⁷⁻³⁰ and carboxyls³¹ of CNCs and CNFs²⁸⁻³¹ to more hydrophobic long alkyl chains^{27, 30, 31} or acetyl groups^{28, 29}. Bromine esterification, a common reaction to introduce alkyl bromines to cellulose, has been performed on sulfuric acid hydrolyzed CNC³³ and TEMPO-oxidized and homogenized CNF³⁴ using 2-bromoisobutyryl bromide (BIB) aided by 4-dimethylaminopyridine (DMAP) catalyst to improve their respective dispersity in DMF³³ and anisole³⁴. To date, efforts to generated hydrophobic nanocelluloses have been limited and mainly from modification of already fabricated nanocelluloses²⁷⁻³⁴.

Producing hydrophobic nanocelluloses from modification of cellulose is even more scarce. Esterification of cellulose with acetic anhydride followed by refining, cryo-crushing and homogenization has shown to generate ethanol and acetone suspensible cellulose and 10-50 nm wide CNFs, but the extent of CNFs was not reported³⁵.

### BRIEF SUMMARY

In one aspect, the present disclosure provides a composition comprising bromine esterified nanocellulose, wherein the bromine esterified nanocellulose is at least 25% dispersible in an organic media.

In some embodiments, the organic media is DMF, DMSO, chloroform. THF, toluene, or acetone. In particular embodiments, the organic media is DMF.

In some embodiments, the bromine esterified nanocellulose is between 1 and 6.5 nm thick, between 2 and 30 nm wide, and between 325 and 1000 nm long. In certain embodiments, the bromine esterified nanocellulose is about 4.6 nm thick, about 29.3 nm wide, and about 1 μm long. In certain embodiments, the bromine esterified nanocellulose has a crystallinity of at least 20%. In particular embodiments, the bromine esterified nanocellulose has a crystallinity of about 47.8%.

In another aspect, the disclosure provides a method for producing hydrophobic bromine esterified nanocellulose, comprising: (a) combining, in a reaction mixture, cellulose and a bromine provider in an organic media to produce bromine esterified cellulose; (b) ultrasonicate the mixture of (a) to disintegrate the bromine esterified cellulose into bromine esterified nanocellulose, wherein both steps (a) and (b) are performed in one container.

In some embodiments, the bromine provider is 2-bromopropionyl bromide (BPB) or 2-bromoisobutyryl bromide (BIB). In certain embodiments, the bromine provider is 2-bromopropionyl bromide (BPB).

In certain embodiments of the method, the ratio of the bromine provider to anhydroglucose units (AGUs) in the cellulose is between 1:1 and 10:1 molar ratios. In certain embodiments, the ratio of the bromine provider to AGUs in the cellulose is 5:1 molar ratio.

In some embodiments of the method, the organic media is DMF, DMSO, chloroform, THF, toluene, or acetone. In particular embodiments, the organic media is DMF.

In some embodiments, the method is performed at a temperature of between 23° C. and 70° C. In particular embodiments, the method is performed at 23° C.

In some embodiments of the method, the ultrasonication of step (b) is performed at an amplitude of between 25% and 100%. In certain embodiments, the ultrasonication of step (b) is performed at an amplitude of 50%. In some embodiments, the ultrasonication of step (b) is performed for a duration of between 10 minutes and 120 minutes. In particular embodiments, the ultrasonication of step (b) is performed for a duration of about 30 minutes.

In some embodiments of the method, the hydrophobic bromine esterified nanocellulose is at least 25% dispersible in the organic media. In certain embodiments, the bromine esterified nanocellulose is between 25% to 45% dispersible in the organic media.

In some embodiments, the bromine esterified nanocellulose produced is between 1 and 6.5 nm thick, between 2 and 30 nm wide, and between 325 and 1000 nm long. In particular embodiments, the bromine esterified nanocellulose produced is about 4.6 nm thick, about 29.3 nm wide, and about 1 μm long.

In some embodiments, the method produces the bromine esterified nanocellulose at a yield of at least 20%. In certain embodiments, the method produces the bromine esterified nanocellulose at a yield of about 70.9%.

In certain embodiments, the method produces the bromine esterified nanocellulose at a crystallinity of at least 20%. In particular embodiments, the method produces the bromine esterified nanocellulose at a crystallinity of about 47.8%.

In another aspect, the disclosure features a polyurethane produced by reacting the composition comprising bromine esterified nanocellulose described herein, with 1,4-butadiol chain extender OHs or polytetramethylene ether glycol soft segment OHs. In some embodiments, the bromine esterified nanocellulose makes up about 0.05 weight percent of all the reactants.

In another aspect, the disclosure features a poly(lauryl methacrylate) (PLMA) produced by reacting the composition comprising bromine esterified nanocellulose described herein with lauryl methacrylate (LMA) in an organic media. In some embodiments, the reaction to make PLMA further comprises a catalyst and a ligand. In certain embodiments, the catalyst is a CuBr. In certain embodiments, the ligand is N,N,N′,N′N″-pentamethyldiethylenetriamine (PMDETA). In certain embodiments, the reaction to make PLMA is performed in DMF, DMSO, chloroform, THF, toluene, or acetone.

### Definitions

As used herein, the term “about” refer to a close range surrounding a explicit value. If “X” were the value, “about X” or “around X” would indicate a value from 0.9X to 1.1X, “About X” thus includes, for example, a value from 0.95X to 1.05X, or from 0.98X to 1.02X, or from 0.99X to 1.01X. Any reference to “about X” or “around X” specifically indicates at least the values X, 0.90X, 0.91X, 0.92X, 0.93X, 0.94X, 0.95X, 0.96X, 0.97X, 0.98X, 0.99X, 1.01X, 1.02X, 1.03X, 1.04X, 1.05X, 1.07X, 1.08X, 1.09X, and 1.10X. Accordingly, “about X” and “around X” are intended to teach and provide written description support for a claim limitation of, e.g. “0.98X.”

As used herein, the ten “bromine provider” refers to any electrophilic compounds having one or mom bromines that can react with one or more hydroxyls on the cellulose to produce esterified cellulose.

### BRIEF DESCRIPTION OF THE DRAWINGS

FIGS. 1A-1E: Br content (a) in Br-Cell as affect by reaction conditions: (A) BPB:AGU molar ratio (23° C., 12 h); (B) reaction time (5.1 BPB:AGU, 23° C.); (C) temperature (5:1 BPB:AGU, 6 h); (D) 1% DMF dispersion immediate and 10 min after vortexing; (E) microfiber dimensions.

FIG. 2: Yields and morphology of Br-NCs (5 k rpm, 10 min) from ultrasonication (50% amplitude, 10-120 min) of Br-Cell2 (3.4 mmol/g), Br-Cell3 (5.7 mmol/g), and Br-Cell4 (8.7 mmol/g). AFM were imaged on highly oriented pyrophoric graphite (HOPG) with corresponding yield and Br-CNF thickness.

FIGS. 3A and 3B: Morphology of Br-CNF3 (0.0005 w/v %, 10 mL) supernatant (5 k rpm, 10 min) from ultrasonication (50% amplitude, 30 nm): (A) AFM image on graphite, height profile, and height distribution; (B) TEM images on glow-discharged carbon grid with width distribution.

FIGS. 4A-4C: Characterizations of cellulose, Br-Cell1-4, Br-CNF3 and Br-Cell3 precipitate: (A) FT-IR spectra; (B) TGA; and (C) DTGA curves. Moisture (%) was the mass loss at 140° C.

FIGS. 5A-5D: (A) Structure and proton assignment of Br-CNF3; Br-CNF3 ¹H NMR spectra in DMSO-d6 via solvent exchange from acetone evaporated at (B) 50° C. and (C) 80° C. vacuum chamber; (D) Integral values of H1-6′, Ha and Hb with corresponding DSuta, DSn, and DSNma. DSHa and DSHb were calculated using eqn. (4) and eqn. (5) whereas DS_{NMR} was their average.

FIGS. 6A-6D: Crystalline structure of cellulose, Br-Cell and Br-CNF3: (A) XRD spectra; (B) crystallinity (CrI) and crystal parameters calculated by the Scherrer equation (3); (C) Br-CNF cross-section with cellulose chains represented by green rectangles, Br-esterified (1-10) and (110) plane surfaces with thickness (T), width (W), and length (L) indicated; inset shows cellulose Iβ monoclinic unit cell; (D) Degree of substitution (DS_{σ}) calculated from Br-CNF dimensions based on the cross-section shown in C.

FIGS. 7A-7I: Br-CNF3 on substrates: (A) individual substrates with WCAs indicated; AFM (B,C) and TEM (D,E) images of Br-CNF3 (10 μL, 0.0005 w/v %) on corresponding substrates above; (F-I) AFM images and WCAs of Br-CNF3 air-dried on graphite at: (F) 0.0005 w/v %, (G) 0.001 w/v %, (H) 0.005 w/v, and (1) 0.01 w/v % concentrations.

FIGS. 8A-8F: Scaled up generation of Br-CNF3 from ultrasonication (50% amplitude, 30 min) and their viscosity and gel characteristics: (A) Br-CNF yields and supernatant concentrations as related to initial Br-Cell3 concentrations in DMF; (B) UV-vis spectra; (C) images of Br-CNF supernatants and gel at above 0.5 w/v %; (D) viscosity at varied shear rates; (B) optical microscopy of 0.5 w/v % Br-CNF gel; (F) WCA of film by blade coating 1 mm Br-CNF3 (2.5 w/v %) gel on glass, and air dried.

FIGS. 9A and 9B: Scheme for polyurethane synthesis with Br-CNFs serving as: (FIG. 9A) chain extender, (FIG. 9B) polyol; at the same 2.2:1:1 NCO_{MDI}: OH_{PTMEG-Br-CNF}: OH_{1,4-BD+Br-CNF} molar ratio.

FIGS. 10A-10C: Tensile properties of PU synthesized with Br-CNF as chain extender to replace 11 and 30 mol % of 1,4-BD hydroxyls at 2.2:1:1 NCO_{MDt}: OH_{PTMEG}:OH_{1,4-BD+Br-CNF}: (FIG. 10A) representative stress-strain curves for PU/CNF films (n≥3) with Br-CNF (w %) compositions and photographic images of PU/CNF films; (FIG. 10B) tensile stress and strain-to-failure; (FIG. 10C) Experimental and Halpin-Tsai simulated elastic modulus (MPa)(n≥3).

FIGS. 11A-11C: Tensile properties of PU synthesized with Br-CNFs as polyols replacing 0.3, 0.6, 1.2, 1.8 and 3.1 mol % OHs in PTMEG (Mn:2,900 Da) diol at 2.2:1:1 NCO_{MDt}:OH_{PTMEG+Br-CNF}:OH_{1,4-BD} mole ratio: (FIG. 11A) representative stress-strain curves for PU/CNF films with 0.05, 0.1, 0.3, and 05 w % Br-CNF; photographic images of the upper portions of fractured samples and 1.8 w % Br-CNF (11 mol % of 011 in 1,4-BD) as chain extender (CE) from FIG. 10A for comparison; (FIG. 11B) tensile stress (MPa) and strain-to-failure (%); (FIG. 11C) Experimental and Halpin-Tsai simulated elastic modulus (MPa) of PU/CNF films (n≥23).

FIGS. 12A-12C: Tensile properties of PU synthesized with 0.3 w % Br-CNF polyol in PTMEG (Mn:2,900 Da) diol with 0 to 10 mol % excess MDI (2-2.2:1:1 NCO_{MDI}:OH_{PTMEG+Br-CNF}:OH_{1,4-BD}): (FIG. 12A) representative stress-strain curves with compositions in w %; (FIG. 12B) tensile stress and strain; (FIG. 12C) modulus (n≥23).

FIGS. 13A and 13B: Tensile properties of PU synthesized with Br-CNFs as polyols and either 1,000 or 2,900 Da PTMEG at a consistent 2.2:1:1 NCO_{MDI}:OH_{PTMEG+Br-CNF}: OH_{1,4-BD}: (FIG. 13A) Representative stress-strain curves; (FIG. 138) elastic modulus, tensile stress, and strain-to-failure (n≥3), with compositions (w %).

FIGS. 14A and 14B: Characteristics of PU/CNF composites with Br-CNF as polyol (0.1, 0.3, 0.5 w %) or extender (1.8 and 5.4 w %): (FIG. 14A) attenuated total reflectance (ATR) spectra; (FIG. 14B) differential scanning calorimetry thermograms.

FIGS. 15A-15C Cyclic tensile properties of PU/CNF films with Br-CNF (w %) as polyol at 400% strain for 5 cycles: (FIG. 15A) cyclic stress-stain curves; (FIG. 15B) 1^{st} cyclic stress-strain curves. (FIG. 15C) 1^{st} tensile stress and cycle recovery (%). All films are synthesized with at 2.2:1:1 NCO_{MDI}:OH_{PTMEG+Br-CNF}:OH_{1,4-BD} and PTMEG (Mn=2,900 Da).

FIGS. 16A-16F: Optical microscopy images of PU/CNF films (0.4 mm thickness), with 0.5 w % Br-CNF as polyol: (FIG. 16A) as is, (FIG. 16B) under ca. 300% strain (direction shown by arrow), (FIG. 16C) fractured edge; with 1.8 w % Br-CNF as chain extender: (FIG. 16D) as is, (FIG. 16H) under ca. 300% strain (direction shown by arrow); with 3.4 w % Br-CNF as lone extender: (FIG. 16F) as is. Upper right insets were corresponding images under cross-polar.

FIGS. 17A-17C: SI-ATRP of LMA ([M]ₒ=800 or 1,600 mM) on Br-CNF ([I]=9.6 or 16 mM) at 70° C.: (FIG. 17A) conversion, (FIG. 17B) In ([M]ₒ/[M]), (FIG. 17C) DPₘₐₛₛ.

FIGS. 18A and 18B: Plot of (FIG. 18A) inherent (lmᵣ/C) verse concentration (C) for Br-CNF-g-PLMA in toluene; (FIG. 18B) Mₙ verse estimated DPₘₐₛₛ by eqn (1) with calculated intrinsic viscosities.

FIGS. 19A-19D: Characterization of Br-CNF and Br-CNF-g-PLMA: (FIG. 19A) ATR spectra; (FIG. 19B) TGA; (FIG. 19C) DTGA curves; and (FIG. 19D) moisture and char residue in relationship to Br-CNF contents.

FIGS. 20A-20C: ¹H NMR spectra of Br-CNF and Br-CNF-g-PLMA in DMSO-d (color coded in c): (FIG. 20A) Spectra with assigned protons; (FIG. 20B) Proton assignment for Br-CNF backbone and PLMA chains; (FIG. 20C) DP_{NMR} integral of Br-CNF 2-6′protons and PLMA methylene g protons.

FIGS. 21A-21E: AFM images on HOPG: (FIG. 21A) Br-CNF in DMF; Br-CNF-g-PLMA in toluene (FIG. 21B) DPₘₐₛₛ=3, (FIG. 21C) DPₘₐₛₛ=46, all from 10 μL at 0.0005 w/v %; (FIG. 21D) UV-vis spectra of Br-CNF-g-PLMA (1 w/v %, toluene). (FIG. 21E) WCAs on films cast from Br-CNF-g-PLMA with varied DPₘₐₛₛ.

FIGS. 22A and 22B: Br-CNF-g-PLMA toluene dispersions (16, 32, 40, 46 DPmass): (FIG. 22A) Flow behavior index (n) at varied concentrations; (FIG. 22B) Viscosity (10 w/v %) at varied shear rates.

FIGS. 23A and 23B: Viscosity of Br-CNF-g-PLMA with varied DP₅ in toluene in relationships to: (FIG. 23A) concentration at 25° C.; (FIG. 23B) temperature at 4 w/v %. Average viscosity at shear rates from 1 to 220%¹ were used.

FIGS. 24A-24C: Rheology of: (FIG. 24A) Br-CNF in DMF, (FIG. 24B) Br-CNF-g-PLMA (DPₘₐₛₛ=46) in pump oil, and (FIG. 24C) viscosity verse shear rate at temperatures of 25° C. 40° C. and 55° C.

### DETAILED DESCRIPTION

### I. Introduction

The present disclosure provides organic media compatible bromine esterified nanocellulose that is made from a one-pot reaction where cellulose and a bromine provider are first mixed to produce bromine esterified cellulose, which then goes through a disintegration process of ultrasonication to make bromine esterified nanocellulose. The bromine esterified nanocellulose is at least 25% dispersible in an organic media, such as DMF, DMSO, chloroform, THF, toluene, or acetone.

The inventors have successfully established the one-pot solventless telomerization of 1,3-butadiene on cellulose to introduce 2,7-octadienyl ether (ODE), an 8-carbon diene, then mechanical blending of aqueous ODE-cellulose suspensions to generate hydrophobic ODE-nanocellulose in the precipitates that were 27-41% dispersible in DMF, DMSO, and chloroform³⁶. To advance this direct functionalization-disintegration of cellulose approach to produce hydrophobic nanocelluloses, one-pot synthesis of hydrophobic cellulose followed by direct disintegration in organic media into hydrophobic nanocelluloses would further simplify the process.

First and foremost, rationally designed bromine esterification was applied to convert the accessible cellulose C2, C3 and C6 hydroxyls into organic compatible bromine esters. While both 2-bromopropionyl bromide (BPB)³⁷ and 2-bromoisobutyryl bromide (BIB)³⁸ were effective in acylating ionic liquid dissolved wood pulp cellulose to become DMF soluble, the more chemically stable BPB with secondary carbon as relatively poor nucleophile was selected to be the bromine provider for the direct esterification of cellulose solids. The extent of bromine esterification of cellulose necessary to allow disintegration in organic media was studied by sequentially varying bromine provider BPB quantity to anhydroglucose unit (AGU) from 1:1 to 10:1 molar ratios, reaction times (1-12 h), then temperatures (23-90° C.). DMF, a common solvent for cellulose ester^{39, 40}, was used as the reaction as well as dispersing media for disintegrating bromine esterified cellulose (Br-Cell) into bromine esterified nanocelluloses (Br-NCs) by ultrasonication. Ultrasonication that has shown to be effective to disintegrate TEMPO-oxidized wood cellulose (0.01 w/v %) in aqueous media into 3.6 (±0.3) nm wide CNF with ca. 100 length-to-width ratio⁴¹ was carried out in varying amplitudes and lengths of time to provide a range of power. The optimal bromine esterification reaction and ultrasonication power were determined by evaluating the quantities and qualities of DMF-dispersible Br-NCs imaged by atom force microscopy (AFM) and transmission electron microscopy (TEM). The structures of Br-CNFs were further characterized by Fourier-transform infrared (FTIR) and liquid phase proton nuclear magnetic resonance (¹H NMR) spectroscopy. Thermal properties and crystallinity of Br-CNFs were characterized by thermogravimetric analysis (TGA) and X-ray diffraction (XRD), respectively. Moreover, the viscosity and wetting behaviors of thin layer hydrophobic Br-NCs on HOPG or blade coated film on glass were evaluated by water contact angle (WCA) measurement for potential surface modification and coating applications.

Hydrophobic bromine esterified cellulose nanofibrils (Br-CNFs) have been facilely produced via one-pot esterification of cellulose with 2-bromopropionyl bromide (BPB) then directly disintegrated in DMF by ultrasonication. Br-CNFs optimally produced by this streamlined Br-esterification-ulrasonication approach, i.e., 5:1 BPB to anhydroglucose (AGU) molar ratio, 23° C., 6 h and ultrasonication (50% amplitude, 30 min), were 4.6 nm thick, 29.3 nm wide, and 1 μm long in 70.9% yield and 47.8% crystallinity. Successful cellulose hydroxyl to bromine ester conversion was confirmed by the presence of alkyl bromine by FTIR and ¹H NMR. The degree of substitution (DS) of hydroxyl to ester was determined to be between 0.53 (DSₜ) based on XRD and Br-CNF dimensions and 0.56 (DS_{NMR}) from solution-state ¹H NMR. Br-CNF dispersions in DMF exhibited Newtonian behaviors at concentrations below and shear thinning behavior above 0.5%, enabling homogeneous deposition at dilute concentrations up to 0.01% into few nm ultra-thin layers as well blade coating of gel into ca. 100 μm thick film, all similarly hydrophobic with surface WCAs in the range of 70-75°. The ultra-high modulus and strength film from gel coating further shows the potential for dual high-strength and hydrophobic applications.

As described in detail herein, the organic media compatible bromine esterified nanocellulose can also be used as chain extenders or polyol in the syntheses of polyurethanes (PUs). The bromine esterified nanocellulose can replace a portion of 1,4-butadiol chain extender OHs or a portion of polytetramethylene ether glycol soft segment OHs in the production of PUs. The resulting PUs exhibited increased modulus and strain compared to PUs produced without the organic media compatible bromine esterified nanocellulose.

Moreover, the organic media compatible bromine esterified nanocellulose can also function as a robust macroinitiator to self surface-initiated atom transfer radical polymerization (SI-ATRP) of lauryl methacrylate (LMA) in controlled and defined graft lengths in high conversions, i.e., up to 92.7%.

### II. Bromine Esterified Nanocellulose

The disclosure provides a composition comprising bromine esterified nanocellulose that is at least 25% dispersible in an organic media. In some embodiments, the bromine esterified nanocellulose is, e.g., at least 25%, 30%, 35%, 40%, 45%, or 50% dispersible in an organic media. In some embodiments, the bromine esterified nanocellulose is between 25% to 45%, between 25% to 40%, between 25% to 35%, between 25% to 30%, between 30% to 45%, between 35% to 45%, or between 40% to 45% dispersible in an organic media. In some embodiments, the bromine esterified nanocellulose is at least 50% (e.g., 50%, 60%, 70%, 80%, 90%, 95%, or 100% A) dispersible in an organic media (e.g., DMF). In particular embodiments, the bromine esterified nanocellulose is at least 90% (e.g., 90%, 95%, or 100%) dispersible in an organic media (e.g., DMF). In certain embodiments, the bromine esterified nanocellulose is 100% dispersible in an organic media (e.g., DMF).

The bromine esterified nanocellulose presented herein are produced in situ in a one-pot reaction in an organic media. Previously, existing functionalized nanocellulose was most commonly made by first modifying already fabricated or existing nanocellulose via either a solvent exchange or freeze drying process to be dispersible in an organic media, then functionalized the nanocellulose as a second step. The multi-step processes often yielded nanocellulose with low functionalization and conversion rate.

The organic media compatible bromine esterified nanocellulose made by one-pot esterification and disintegration process is dispersible in a number of organic media, such as DMF, DMSO, chloroform, THF, toluene, and acetone. In particular embodiments, the bromine esterified nanocellulose is dispersible in DMF. In further embodiments, the bromine esterified nanocellulose is at least 25% (e.g., at least 25%, 30%, 35%, 40%, 45%, or 50%, between 25% to 45%, between 25% to 40%, between 25% to 35%, between 25% to 30%, between 30% to 45%, between 35% to 45%, or between 40% to 45%) dispersible in DMF. In some embodiments, the bromine esterified nanocellulose is at least 50% (e.g., 50%, 60%, 70%, 80%, 90%, 95%, or 100%) dispersible in an organic media (e.g., DMF). In particular embodiments, the bromine esterified nanocellulose is at least 90% (e.g., 90%, 95%, or 100%) dispersible in an organic media (e.g., DMF). In certain embodiments, the bromine esterified nanocellulose is 100% dispersible in an organic media (e.g., DMF).

In some embodiments, the bromine esterified nanocellulose described herein is between 1 and 6.5 nm (e.g., between 1 and 6 nm, between 1 and 5.5 nm, between 1 and 5 nm, between 1 and 4.5 nm, between 1 and 4 nm, between 1 and 3.5 nm, between 1 and 3 nm, between 1 and 2.5 nm, between 1 and 2 nm, between 1 and 1.5 nm, between 1.5 and 6 nm, between 2 and 6 nm, between 2.5 and 6 nm, between 3 and 6 nm, between 3.5 and 6 nm, between 4 and 6 nm, between 4.5 and 6 nm, between 5 and 6 nm, or between 5.5 and 6 nm) thick. In particular embodiments, the bromine esterified nanocellulose is about 4.6 nm thick.

In some embodiments, the bromine esterified nanocellulose described herein is between 2 and 30 nm (e.g., between 2 and 25 nm, between 2 and 20 nm, between 2 and 15 mu, between 2 and 10 nm, between 2 and 8 mm, between 2 and 6 μm, between 2 and 4 nm, between 5 and 30 nm, between 10 and 30 nm, between 15 and 30 un, between 20 and 30 nm, or between 25 and 30 nm) wide. In particular embodiments, the bromine esterified nanocellulose is about 29.3 nm wide.

In some embodiments, the bromine esterified nanocellulose described herein is between 325 and 1000 n (e.g., between 350 and 1000 mm, between 400 and 1000 nm, between 450 and 1000 mu, between 500 and 1000 nm, between 550 and 1000 nm, between 600 and 1000 nm, between 650 and 1000 nm, between 700 and 1000 nm, between 750 and 1000 nm, between 800 and 1000 nm, between 850 and 1000 nm, between 900 and 1000 nm, between 950 and 1000 nm, between 350 and 950 nm, between 350 and 900 nm, between 350 and 850 μm, between 350 and 800 nm, between 350 and 750 nm, between 350 and 700 nm, between 350 and 650 nm, between 350 and 600 nm, between 350 and 550 nm, between 350 and 500 am, between 350 and 450 am, or between 350 and 400 nm) long. In particular embodiments, the bromine esterified nanocellulose is about 1 μm long.

The bromine esterified nanocellulose that is at least 25% (e.g., at least 50%, 60%, 70%, 80%, 90%, or 95%; 100%) dispersible in an organic media (e.g., DMF) can be cellulose nanocrystals (CNCs) or cellulose nanofibrils (CNFs). The bromine esterified nanocellulose described herein can be isolated by a disintegrating process of ultrasonication of the reaction mixture containing cellulose and a bromine provider. In some embodiments, the isolated bromine esterified nanocellulose can have a crystallinity of at least 20% (e.g., at least 25%, 30%, 35%, 40%, 45%, 50%, 55%, or 60/). In particular embodiments, the bromine esterified nanocellulose has a crystallinity of about 47.8%.

The bromine esterified nanocellulose described herein is compatible with organic media, as well as with polymers, which make it adaptable for broader applications in polymer material processing and synthesis. As described in detail further herein, the bromopropionyl esterification was applied to convert the accessible cellulose C2, C3, and C6 hydroxyls into organic compatible 2-bromopropanoates. The extent of esterification of the cellulose is also important and necessary to allow further disintegration via ultrasonication in organic media possible.

### III. Methods of Production

The present disclosure also provides methods for producing hydrophobic bromine esterified nanocellulose. The methods include: (a) combining, in a reaction mixture, cellulose and a bromine provider in an organic media to produce bromine esterified cellulose; (b) ultrasonicate the mixture of (a) to disintegrate the bromine esterified cellulose into bromine esterified nanocellulose, wherein both steps (a) and (b) are performed in one container. In some embodiments, the methods further include the stop of isolating bromine esterified nanocellulose from the mixture of (b). In certain embodiments, the step of isolating can be performed via centrifugation of the mixture of (b), in which the bromine esterified nanocellulose remains in the supernatant and other materials, such as less esterified or unesterified materials, remain in the precipitate after centrifugation. In other embodiments, the step of isolating can be performed via filtering, during which the bromine esterified nanocellulose remains in the supernatant while other materials remain in the precipitate.

The bromine provider used in the step (a) of the methods can be any electrophilic compounds having one or more bromines that can react with one or more hydroxyls on the cellulose to produce esterified cellulose. In some embodiments, the bromine provider reacts with at least one hydroxyl (e.g., C2, C3, or C6 hydroxyl) on the cellulose. In other embodiments, the bromine provider reacts with two or three hydroxyls (e.g., C2 and C3 hydroxyls, C2 and C6 hydroxyls, C3 and C6 hydroxyls, or C2, C3, and C6 hydroxyls) on the cellulose. In certain embodiments, the bromine provider reacts with C2, C3, and C6 hydroxyls on the cellulose. The bromine provider can be 2-bronopropionyl bromide (BPB), 2-bromoisobutyryl bromide (BIB), carboxylic acid, or acetic anhydride. In certain embodiments, the bromine provider is 2-bromopropionyl bromide (BPB) or 2-bromoisobutyryl bromide (BIB). In particular embodiments, BPB is used in step (a) of the methods. In particular embodiments, BPB reacts with C2, C3, and C6 hydroxyls on the cellulose.

Cellulose is a linear macromolecule in which anhydroglucose unit (AGU) are linked by β-1,4-glucosidic bonds. The molar ratio of the bromine provider (e.g., BPB) to the AGU in the cellulose can affect the extent of the esterification and also the downstream disintegration by ultrasonication. In some embodiments of the methods of producing bromine esterified nanocellulose, the ratio of the bromine provider to the anhydroglucose units (AGUs) in the cellulose is between 1:1 and 10:1 molar ratios (e.g., between 1:1 and 9:1, between 1:1 and 8:1, between 1:1 and 7:1, between 1:1 and 6:1, between 1:1 and 5:1, between 1:1 and 4:1, between 1:1 and 3:1, or between 1:1 and 2:1 molar ratios). In particular embodiments, the ratio of the bromine provider to AGUs in the cellulose is about 5:1 molar ratio.

The organic media the methods are performed in can be, for example, DMF, DMSO, chloroform, THF, toluene, and acetone. Particularly, the steps of the methods can be performed in DMF in situ.

Esterification conditions such as temperature, reaction time, and amplitude and duration of ultrasonication can also affect the extent of cellulose esterification. In certain embodiments, the method is performed at a temperature of between 23° C. and 70° C. As described herein, degration of cellulose was observed at higher temperatures. In some embodiments, the method is performed at a temperature of between 23° C. and 70° C., between 23° C. and 60° C., between 23° C. and 50° C., between 23° C. and 40° C., between 23° C. and 30° C., between 23° C. and 25° C., between 25° C. and 70° C., between 30° C. and 70° C., between 35° C. and 70° C., between 40° C. and 70° C., between 45° C. and 70° C., between 55° C. and 70° C., between 60° C. and 70° C., or between 65° C. and 70° C. In particular embodiments, the method is performed at around 23° C.

After step (a) of reacting the bromine provider with the cellulose, step (b) of the method includes disintegrating the bromine esterified cellulose into bromine esterified nanocellulose by way of ultrasonication in the same organic media that step (a) is performed in. Ultrasonication can be carried out at a range of power levels by varying amplitudes and lengths of time. The optimal esterification reaction and ultrasonication power can be determined by evaluating the quantities and qualities of organic media dispersible bromine esterified nanocellulose imaged by atom force microscopy (AFM) and transmission electron microscopy (TEM). In some embodiments, the ultrasonication of step (b) of the method can be performed at an amplitude of between 25% and 100% (e.g., between 25% and 90%, between 25% and 80%, between 25% and 70%, between 25% and 60%, between 25% and 50%, between 25% and 40%, between 25% and 30%, between 30% and 100%, between 40% and 100%, between 50% and 100%, between 60% and 100%, between 70% and 100%, between 80% and 100%, or between 90% and 100%). In certain embodiments, the ultrasonication of step (b) is performed at an amplitude of about 50%.

The duration of ultrasonication can also be varied either independently or in combination with the amplitude of ultrasonication. In some embodiments, ultrasonication of step (b) can be performed for a duration of between 10 minutes and 120 minutes (e.g., between 10 minutes and 110 minutes, between 10 minutes and 100 minutes, between 10 minutes and 90 minutes, between 10 minutes and 80 minutes, between 10 minutes and 70 minutes, between 10 minutes and 60 minutes, between 10 minutes and 50 minutes, between 10 minutes and 40 minutes, between 10 minutes and 30 minutes, or between 10 minutes and 20 minutes). In certain embodiments, the ultrasonication of step (b) can be performed for a duration of about 30 minutes.

In certain embodiments, the methods for producing hydrophobic bromine esterified nanocellulose can include: (a) combining, in a reaction mixture, cellulose and a bromine provider (e.g., BPB) in an organic media (e.g., DMF) to produce bromine esterified cellulose; (b) ultrasonicate the mixture of (a) (e.g., at about 50% amplitude for about 30 minutes) to disintegrate the bromine esterified cellulose into bromine esterified nanocellulose, wherein both steps (a) and (b) are performed in one container. In some embodiments, the methods further include the step of isolating bromine esterified nanocellulose from the mixture of (b) by way of centrifugation, in which the bromine esterified nanocellulose remains in the supernatant after centrifugation.

The methods described herein can produce hydrophobic bromine esterified nanocellulose at a yield of at least 20% (e.g., at least 30%, at least 40%, at least 50%, at least 60%, at least 70%, at least 80%, or at least 90%). Particularly, the methods can produce bromine esterified nanocellulose at a yield of between 20% and 95% (e.g., between 20% and 90%, between 20% and 80%, between 20% and 70%, between 20% and 60%, between 20% and 50%, between 20% and 40%, between 20% and 30%, between 30% and 95%, between 40% and 95%, between 50% and 95%, between 60% and 95%, between 70% and 95%, between 80% and 95%, or between 90% and 95%). In certain embodiments, the methods produce bromine esterified nanocellulose at a yield of about 70.9%.

The hydrophobic bromine esterified nanocellulose produced by methods described herein is at least 25% dispersible (e.g., at least 25%, 30%, 35%, 40%, 45%, or 50% dispersible) in the organic media (e.g., DMF). In some embodiments, the bromine esterified nanocellulose is at least 50% (e.g., 50%,60%, 70%, 80%, 90%, 95%, or 100%) dispersible in an organic media (e.g., DMF). In particular embodiments, the bromine esterified nanocellulose is at least 90% (e.g., 90%, 95%, or 100%) dispersible in an organic media (e.g., DMF). In certain embodiments, the bromine esterified nanocellulose is 100% dispersible in an organic media (e.g., DMF).

### IV. Uses of Bromine Esterified Nanocellulose

The organic media compatible bromine esterified nanocellulose described herein can be used in a variety of applications. In one example, the bromine esterified nanocellulose can partially replace either chain extender or polyol in the stoichiometrically optimized syntheses of polyurethanes (PUs). PUs polymerized with a portion of bromine esterified nanocellulose in the synthesis exhibited a large increase in modulus, strength, and strain. The disclosure also features a polyurethane produced by reacting the bromine esterified nanocellulose described herein with 1,4-butadiol chain extender OHs or polytetramethylene ether glycol soft segment OHs. In some embodiments, the polyurethane contains at least 0.05 (e.g., at least 0.1, at least 0.15, at least 0.2, at least 0.25, at least 0.3, at least 0.35, at least 0.4, at least 0.45, or at least 0.5) weight percent (w %) of bromine esterified nanocellulose described herein. In certain embodiments, the polyurethane contains about 0.3 w % of bromine esterified nanocellulose described herein. In certain embodiments, the polyurethane contains about 1.5 w % of bromine esterified nanocellulose described herein. The bromine esterified nanocellulose can replace about 11 mol % of 1,4-butadiol chain extender Oils, which results in about 1.5 w % of bromine esterified nanocellulose in the polyurethane. In other embodiments, the bromine esterified nanocellulose can replace about 1.8 mol % of polytetramethylene ether glycol soft segment OHs, which results in about 0.3 w % of bromine esterified nanocellulose in the polyurethane.

Further, the bromine esterified nanocellulose described herein can also function as a macroinitiator to self surface-initiated atom transfer radical polymerization (SI-ATRP) of lauryl methacrylate (LMA). The resulting Br-CNF-g-PLMA exhibited combined shear thinning behavior of Br-CNF and drag reducing effects of PLMA with highly increased viscosity. Moreover, Br-CNF-g-PLMA could be fully dispersed in silicon pump oil to function as drag reducer to enhance viscosity. A poly(lauryl methacrylate) (PLMA) can be produced by reacting the bromine esterified nanocellulose described herein with lauryl methacrylate (LMA) in an organic media, such as DMF, DMSO, chloroform, THF, toluene, or acetone (e.g., DMF). The reaction can further include a catalyst and/or a ligand. Examples of a catalyst include, but are not limited to, CuBr, FeBr₂, FeBr₃, and other transition metals such as Zn, Mg, and Fe. Further, examples of a ligand for use in the reaction can include, but are not limited to, N,N,N′,N′,N″-pentamethyldiethylenetriamine (PMDETA), tetradentate, tridentate, and bidentate ligands, such as N,N,N′,N′-tetra[(2-pyridal)methyl]ethylenediamine (TPEDA), 2,2′-bipyridine (BPY), and 1,4,7-trimethyl-1,4,7-triazonane (Me3 TAN).

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1—Synthesis of Bromine Esterified Cellulose (Br-Cell)

Cellulose was isolated from rice straw (Calrose variety) by a previously reported three-step 2:1 v/v toluene/ethanol extraction, acidified NaClO₂ (1.4%, pH 3-4, 70° C., 5 h) delignification, alkaline hemicellulose dissolution (5% KOH, 90° C., 2 h) process and lyophilized (Labconco Lyophilizer).⁴² 2-Bromopropionyl bromide (BPB, 97%, Alfa Aesar), 4-Dimethylaminopyridine (DMAP, 99%, Acros Organics), potassium bromide (KBr, 99.9+%, Fisher Scientific), acetone (histological grade, Fisher Scientific), N,N-dimethylformamide (DMF, certified grade, Fisher Scientific) and trifluoroacetic acid (99%, Sigma Aldrich) were used as received without further purification. All water used was purified by Milli-Q Advantage water purification system (Millipore Corporate, Billerica, MA). For AFM imaging, mica (highest-grade V1 mica discs, 10 mm, Ted Pella, Inc. Redding, CA) and highly oriented pyrolytic graphite (HOPG, grade ZYB) were used. For TEM, carbon grids (300-mesh copper, formvar-carbon, Ted Pella Inc.) were used. For UV-vis spectrophotometry, 1 mm UV-Vis standard cell quartz cuvettes (Fisher Scientific) were used.

Bromine esterification of cellulose was performed at varying bromine provider (BPB) to cellulose anhydroglucose unit (AGU) ratios (1:1 to 10:1 BPB:AGU), reaction times (1 to 12 h), and temperatures (23 to 90° C.) (Scheme 1). Based on 162 g/mol for AGU, there is 6.2 mmol AGU per gram of cellulose- or 0.2 mmol amorphous AGU per gram of cellulose with an estimated 0.67 crystallinity of rice straw cellulose from the avenge 0.618⁴² and 0.7221 by XRD. Freeze-dried cellulose (0.50 g, 3.1 mmol AGU) was added to DMF (30 mL) and stirred until homogeneously dispersed. At 5:1 BPB;AGU, BPB (3.33 g, 15.4 mmol) and DMAP (0.05 g, 0.4 mmol) catalyst were dissolved in DMF (10 mL) in an ice bath under constant vortexing, then added to the cellulose dispersion to start the reaction and stopped by vacuum filtration. The reacted cellulose solids were rinsed with acetone three times to remove residual BPB, DMAP and DMF, then dried at 55° C. overnight to obtain dry bromine esterified cellulose (Br-Cell).

The extent of reaction in Br-Cell was determined by mass gain and expressed as Br content (σ, mmol/g):

$$σ = \frac{{m}_{2} - {m}_{1}}{135 \times {m}_{1}} \qquad ( 1 )$$

where m₁ is the initial cellulose mass (g), m₂ is the dry Br-Cell mass (g), and 135 (g/mol) is the molecular mass gain from hydroxyl to bromine ester.

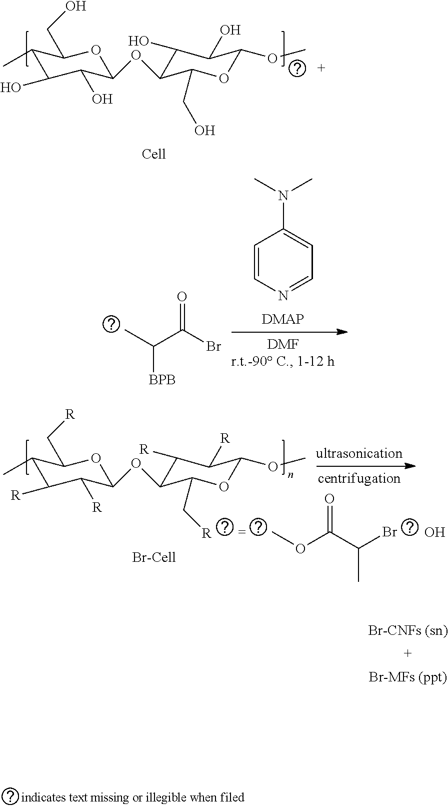

Scheme 1 Bromine esterification reaction of cellulose and ultrasonication to generate hydrophobic Br-CNFs in the supernatant and Br-Cell microfibrils (MFs) in the precipitate.

### Example 2—Generation of Bromine Esterified Nanocelluloses (BR-NCS) by Ultrasonication

Br-Cell (0.1 g) was resuspended in 100 mL DMF at 0.1 w/v % and ultrasonicated (Qsonica Q700, 50/60 Hz) at varied amplitudes (25-100%) and times (10-120 min) in an ice bath and 10-minute time intervals to disintegrate the microfibers. All ultrasonicated dispersions were centrifuged (Eppendorf 5804R, 5 k rpm, 10 min) to collect the clear Br-esterified nanocellulose (Br-NC) containing supernatants and Br-Cell precipitates for further characterization. Mas of r-dried Br-Cell precipitates were determined gravimetrically and subtracted from initial Br-Cell mass to derive the Br-NC quantities in supernatants. The Br-NC as percentage of the initial Br-Cell was reported.

### Example 3—Characterizations

The morphologies of dried Br-Cells were imaged by optical microscopy (Leica DM2500). Br-Cell was redispersed at 0.1 w/v % in DMF and 10 μL droplets were deposited on glass slides to measure the width and length (n>100) of microfibers. Their averages and standard deviations were reported. Br-NCs in DMF dispersions were imaged by AFM and TEM on different substrates. Br-NCs (10 IL, 0.0005 w/v %) were deposited on freshly cleaved hydrophilic mica or relatively hydrophobic highly oriented pyrophoric graphite (HOPG), then air-dried in fume hood for 6 h and profiled by AFM in the tapping mode with scan size and rate set to Sum x Sum and 512 Hz. Br-NCs (10 μL, 0.0005 w/v %) were deposited onto both glow and non-glow discharged carbon-coated TEM grids, and excess liquid was removed after 5 min by blotting with a filter paper. The specimens were negatively stained with aqueous uranyl acetate (2 w/v %) and blotted to remove excess solution with filter paper, repeated five times then dried under the ambient condition for 15 min. The samples were observed using a Philip CM12 transmission electron microscope at a 100 kV accelerating voltage. The lengths and widths of CNFs were measured and calculated using ImageJ Analyzer (ImageJ, NIH, USA).

For ¹H NMR, 40 mL acetone was added into Br-CNF3 in DMF dispersions (10 mL, 0.50 w/v %) followed by centrifugation (5 k rpm, 10 min) to decant the supernatant, repeated three times to prepare Br-CNF3 acetone gel. Br-CNF3 acetone gel (ca. 5 mg) was added into 1 mL DMSO-d6, then sonicated (10 min, Branson 2510) and vacuumed at 50° C. or 80° C. for 1 h, repeated three times to remove residual acetone. After centrifugation (5 k rpm, 10 min), Br-CNF3 in DMSO-de supernatant was collected for ¹H NMR (Bruker AVIII 800 MHz ¹H NMR spectrometer) characterization. Around 1 mL supernatant was placed in one NMR tube with 50 μL trifluoroacetic acid added to shift all OHs peak downfield to above 4.5 ppm.

Transparent FTIR pellets were prepared by mixing 3 mg of oven dried Br-Cell, Br-CNF3 and Br-Cell3 precipitates with 300 mg of spectroscopic grade (99.9+%) potassium bromide (KBr) after 1 min pressurization under 800 MPa barrel chamber, then scanned by Thermo Nicolet 6700 spectrometer under ambient conditions from an accumulation of 64 scans at a 4 cm⁻¹ resolution from 4000 to 400 cm⁻¹. TGA were performed on a TOA-50 thermogravimetric analyzer (Shimadzu. Japan) by heating 5 mg dry sample at 10° C./min from 25 to 500° C. under purging N₂ (50 mL/min).

The crystalline structures were determined by XRD using a PANalytical X'pert Pro powder diffractometer with a Ni-filtered Cu Kα radiation (R=1.5406 A) at 45 kV anode voltage and 40 mA current. Br-Cell3 powder was rinsed three times with acetone and oven-dried (55° C.) overnight. Br-CNF3 film was generated from 0.5 w/v % DMF dispersions by evaporating DMF in fume hood for 7 d. The samples were fixed on stage by double-sided tape, then diffractograms were recorded from 5 to 40° at a scan rate of 2°/min. Crystallinity index (CrI) was calculated using the intensity of the 200 peak (I₂₀₀, 2θ=225°) and the intensity minimum between the peaks at 200 and 1 10 (Iₐₙ, 2θ=19.0°) as follows⁴³

$$CrI = \frac{{I}_{200} - \text{?}}{{I}_{200}} \qquad ( 2 )$$

$$\text{?} \text{indicates text missing or illegible when filed}$$

The crystallite dimensions were calculated using the Scherrer equation⁴⁴

$${D}_{hkl} = \frac{0.9 λ}{{β}_{1 / 2} cos θ} \qquad ( 3 )$$

where Dₕₖₗ is the crystallite dimension in the direction normal to the (h k l) lattice planes, λ is the X-ray radiation wavelength (1.5406 Å), β_{1/2} is the full width at half-maximum of the diffraction peak in radius calculated using peak fitting software (Fityk, 1.3.1).

Br-CNF3 at concentrations of 0.0005 to 0.01 w/v % were deposited on freshly exfoliated graphite an allowed to air-dry for 6 h. 0.5 w/v % Br-CNF3 DMF dispersion was concentrated to 25 w/v % Br-CNF3 organogel by ambient drying in fume hood for 4 d, then 5 mL gel (1 mm thickness) was coated on glass using a Doctor-Blade film coater (INTSUPERMAI Adjustable Film Applicator Coater KTQ-II) as one hundred pm thick film after ambient drying overnight. Water contact angles (WCAs) of sessile drops (5 μL) on fresh mica, exfoliated graphite, carbon, glow-discharged carbon and film coated glass, as well as single and double deposited Br-CNF3 on graphite were measured using the Imagel Analyzer and the average values were calculated from both sides of a sessile drop reported in total of 5 images for each (n=5). The root mean square (RMS) of Br-CNF deposited graphite surfaces were measured from microscopic peaks and valleys of AFM images.

Br-CNF3 in DMF dispersions were serial diluted from 0.5 w/v % to 0.25, 0.13 and 0.06 w/v % then scanned by UV-vis spectroscopy (Thermo Scientific, Evolution 600) from 325 to 800 cm⁻¹ at 4 cm⁻¹/s. Viscosities of Br-CNF3 DMF dispersions were measured at 25° C. with shear rates from 1 to 220 s⁻¹ using a Brookfield DV3T rheometer.

### Example 4—Results and Discussion

### Bromine Esterification of Cellulose

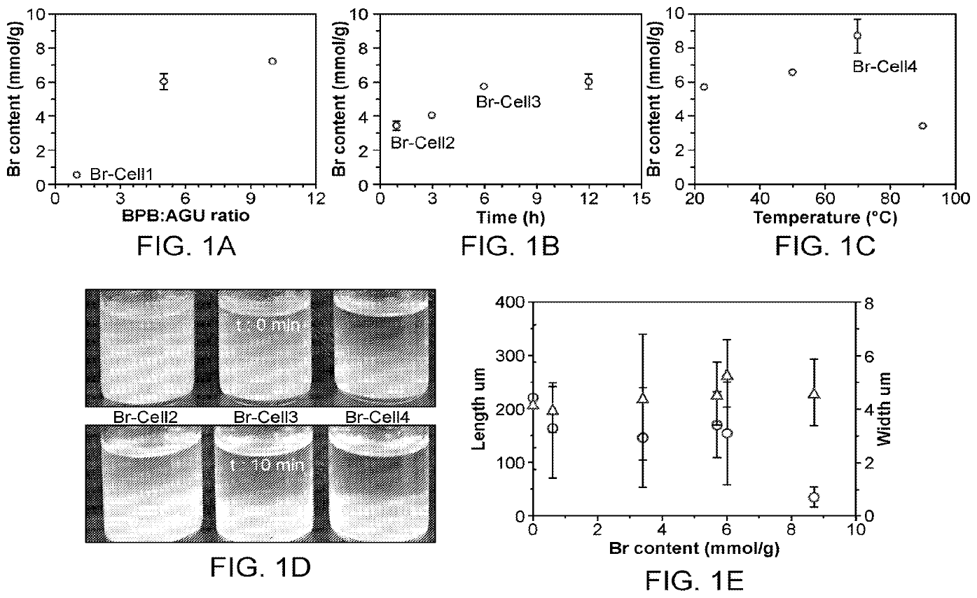

Cellulose was isolated from rice straw at 350*3.3% (n=10) yield, comparable to previous reported value 42, and freeze-dried to a white fluffy mass. Bromine esterification of cellulose was conducted under varying BPB:AGU molar ratios (1:1 to 10:1), reaction times (1-12 h), and temperatures (23-90° C.) to evaluate their effects on the extent of hydroxyl to bromine ester conversion or Br content (a, mmol/g) (Scheme 1). At 23° C. for 12 h, a 5 time increase of BPB:AGU ratio from 1:1 to 5:1 led to a 12 time increase in the Br content (a) from 0.5-6.0 mmol/g while further doubling the ratio only increase a by another 20% to 7.2 mmol/g (FIG. 1A). The optimal 5:1 BPB:AGU ratio was selected to vary the length of reaction at 23° C. Br content (a) increased from 3.4 to 5.7 mmol/g, showing close to linear relationship with reaction time from 1 to 6 h, then to 6.0 mmol/g at 12 h essentially unaffected (FIG. 1B). Under the optimal 5:1 BPB:AGU ratio and 6 h time, increasing temperatures from 23-70 C.° improved Br content (a) from 5.7 to 8.7 mmol/g, but further increase to 90° C. lowered the a to 3.4 mmol/g (FIG. 1C). The significantly reduced a from Br-esterification at 90° C. suggested possible dissolution of the excessively Br-esterified cellulose. Overall, Br-Cell with 0.5 to 8.7 mmol/g a has been facilely produced and easily controlled by the esterification conditions, i.e., 1:1 to 5:1 BPB:AGU ratios, 1-6 h, and 23-70° C. The highest 8.7 mmol/g Br content was achieved by Br esterification conducted at 5:1 BPB:AGU ratio and 70° C. for 6 h.

The DMF dispersibility of 1% Br-Cells with four alkyl bromine levels, i.e., Br-Cell1 (0.6 mmol/g), Br-Cell 2 (3.4 mmol/g), Br-Cell3 (5.7 mmol/g), and Br-Cell4 (8.7 mmol/g), was then observed. The least Br-esterified Br-Cell did not disperse and remained settled even at a lower 0.1% whereas those more esterified Br-Cell2, 3 and 4 were dispersible in DMF to different degrees (FIG. 1D). The Br-Cell 2 and Br-Cell3 DMF dispersions appeared homogeneous and translucent, but Br-Cell4 phase separated immediately (t=0). After 10 min. Br-Cell3 also settled similarly to Br-Cell4 while Br-Cell2 remained somewhat dispersed. Optical microscopic observation showed all four Br-Cells to be microfibers in similar 4-5 mm widths while their lengths reduced by nearly 30% from 221 to ca. 158 mm compared to the original cellulose for all except for the significantly shorter 36 mm long Br-Cell4. While no change in microfiber width, the 84% reduction in their length of BrCell4 with the highest a (8.7 mmol/g) suggested this more extensive Br esterification condition may be close to the onset of chain scission with potential cellulose dissolution. One control reaction at 23° C. for 6 h without adding BPB was performed to induce only 1.1% mass loss, indicating no significant mass lose during filtration and evaporation process. Thus, eqn. (1) is applicable to estimate Br content from mass gain % of cellulose.

### Br-NCs by Ultrasonication

Four Br-Coils with σ from 0.6 to 8.7 mmol/g were ultrasonicated in DMF (0.1 w/v %) at 25-100% amplitudes for 10-120 min to collect the Br-NC containing supernatants. Upon ultrasonication at 50% amplitude for 30 min, the least esterified Br-Cell1 (a from 0.6 mmol/g) produced only 10.6% Br-NCs, essentially the same as the 10.4% NCs from unmodified cellulose under the same ultrasonication condition, indicating Br esterification at 0.6 mmol/g to be insufficient to facilitate disintegration and/or dispersion. The NCs from unmodified cellulose appeared as few larger and thicker (3-20 nm) nanoparticles (NPs) on mica but numerous much smaller and thinner (3 nm) NPs on graphite, indicative of their more hydrophobic surfaces. Among the three mom esterified Br-Cells, more Br-NCs were produced with increasing ultrasonication amplitudes from 25-100% at 60 min, with the highest 97.3% yield for Br-Cell3 (5.7 mmol/g) compared to the modest 56.9 and 73.1% from either the respective les esterified Br-Cell2 (3.4 mmol/g) and the more esterified Br-Cell4 (8.7 mmol/g).

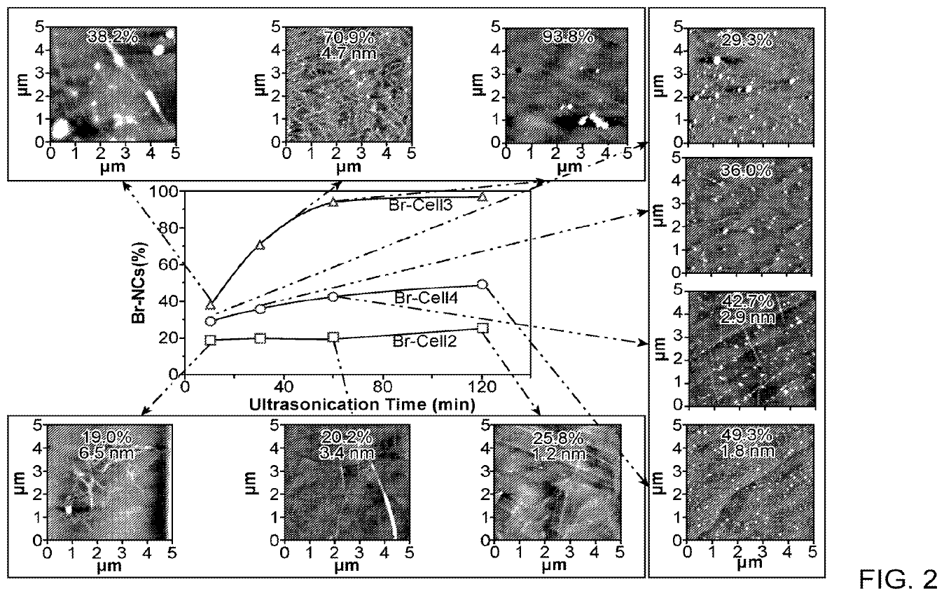

Since a very close second highest yield of 93.8% was produced from Br-Cell3 at half of the amplitude, the effect of ultrasonication time (10-120 min) on the morphology of Br-NCs generated from Br-Cell2-4 was observed at 50% amplitude to conserve energy (FIG. 2). Br-NC yields increased with longer ultrasonication (50% amplitude) for all three Br-Cells; Br-NC yields from Br-Cell3 (5.7 mmol/g) was highest and most time-dependent, ranging from 38.2% to 97.3%, followed by slight time-dependent and modest 29.3 to 49.3% Br-NC yields for Br-Cell4 (8.7 mmol/g) and the least time-dependent and lowest 19.0 to 25.8% Br-NC yields for Br-Cell2 (3.4 mmol/g). However, not all Br-NCs were fibrillar. For the mast DMF dispersible Br-Cell2 (FIG. 1D), nearly all Br-NCs were fibrillar, from entangled to more individualized in reducing thickness of 6.5 to 1.2 nm, but in low yields. The most esterified Br-Cell4 was disintegrated into mostly Br-NPs, also in decreasing sizes, with only few fibrils from longer ultrasonication. Ultrasonication of Br-Cell3 produced 38.2% Br-NCs in the forms of both Br-CNFs and Br-NPs at 10 min, 70.9% Br-CNFs at 30 min, and 93.8% at 60 min all as Br-NPs. As expected, ultrasonication transfers sound energy to disintegrate Br-Cell microfibers into Br-NCs with increasing effects by either higher amplitudes or longer time. The forms and sizes of NCs, however, were found highly dependent on the extent of Br-esterified cellulose. The less esterified (3.4 mmol/g) produced all Br-CNFs but at low yields (19.0 to 25.8%) whereas the most esterified (8.7 mmol/g) produced majority of Br-NPs at modest yields (29.3 to 49.3%). Therefore, Br-Cell3 was deemed optimally esterified (5.7 mmol/g) with sufficient Br esters to be disintegrated by ultrasonication (50%, 30 min) into mostly Br-CNF in 70.9% yield, and 4.6 nm average thickness. Noteworthy, longer ultrasonication of the optimally esterified Br-Cell3 produced 93.8% and 97.0% bromine esterified NPs at respective 1 h and 2 h. Those Br-NPs were potentially attributed to reassembled dissolute cellulose during sonication and would cause decrease of Br-CNFs crystallinity. Therefore, this esterification-ultrasonication approach to functionalize cellulose and disintegrate in functionalize nanocelluloses are highly effective and can be tuned to product either Br-CNFs or Br-NPs efficiently.

### Br-CNF3 Morphology Characterized by AFM and TEM

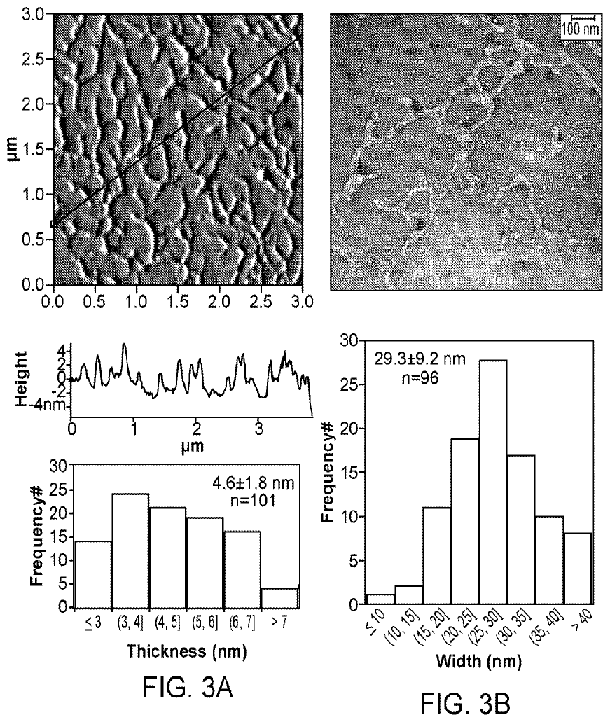

Br-CNF3 generated from optimal ultrasonication (50% amplitude, 30 min) of Br-Cell3 were further imaged by AFM on freshly exfoliated graphite and by TEM on glow discharged carbon grid to display interconnecting nanofibrils with 4.6 nm average thickness (FIG. 3A), 29.2 nm average width, and varying lengths in the order around 1 μm (FIG. 3B). The irregular widths under TEM may be due to the reassociation of the more Br-esterified surface chains along Br-CNF surfaces. Also, under both AFM and TEM, the inter-connecting fibrillar network left few isolated fibrils, making differentiating fibril ends difficult and causing inaccurate estimation of Br-CNF3 length. Similar inter-connecting fibrillar structures were also observed at much more diluted 0.0001 and 0.00005 w/v % concentrations, confirming the inter-connecting fibrillar structures to be independent of concentrations and seemingly mono-layer. The inter-connecting fibrillar network dried from the most concentrated Br-CNF (0.0005 w/v %, on graphite) appeared thinner and more fragmented after exposing to air for 24 h, possibly due to reactions between alkyl bromines and moisture in the air, degrading Br-CNF.

To further elucidate the interaction among Br-CNFs, a second Br-CNF3 droplet was placed on top of the completed dry first (10 μL, 0.0005 w/v %). More heterogenous, condensed and inter-connecting CNFs were observed at the center than near the edge of the first dried droplet. The significant association among Br-CNFs from second deposition as compared to isolated fibrils from the initial single droplet gave evidence to preferential and stronger association among Br-CNFs over affinity of Br-CNF to graphite surface. Association among Br-CNFs may include dipole-dipole interactions between surface esters, hydrogen bonding among unsubstituted surface hydroxyls, and potential chemical reaction between alkyl bromines and remaining hydroxyls in preference to adhesion to the graphite surface from the sequential deposition.

FTIR Spectroscopy and Thermal Analysis of Br-Cell, Br-CNF3 and Br-Cell3 Precipitates

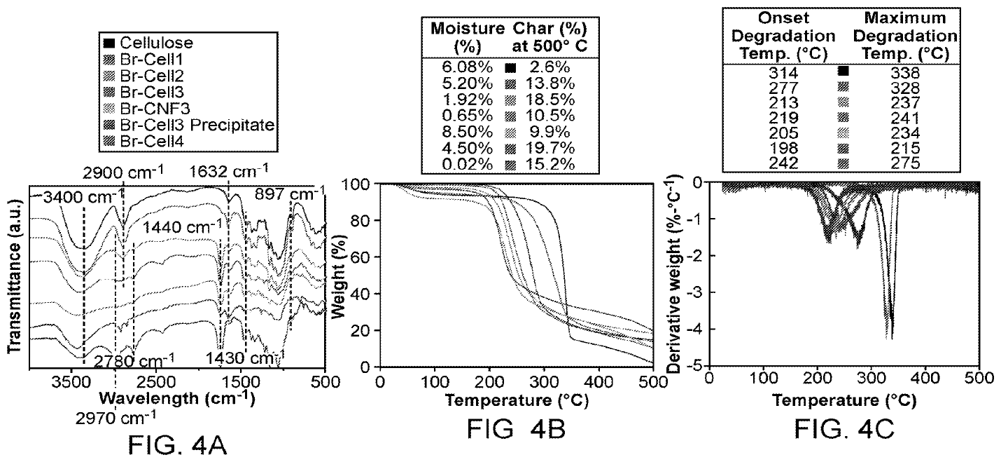

The presence of the new 2-bromopropionyl carbonyl peak at 1740 cm⁻¹ in the FTIR spectra of all four Br-Cells confirmed the successful conversion of cellulose hydroxyls to 2-bromopropionyl group (FIG. 4A). The carbonyl peak (1740 cm⁻¹) intensities increased whereas the cellulose C-H stretching peak (2900 cm⁻¹) reduced in intensities with the increasing Br content (a) from 0.6-8.7 mmol/g. The bromine ester sp³ C-C stretching at 2780 cm⁻¹ appeared for Br-Cell2 and increased with increasing σ, while the most esterified Br-Cell4 also showed intense bromine ester sp C-C stretching at 2970 cm⁻¹. The carbonyl peak (1740 cm⁻¹) on Br-CNF3 remained unchanged from BrCell3, indicating no significant side reaction or degradation on the alkyl bromines by ultrasonication. The stronger carbonyl peak (1740 cm⁻¹) in Br-CNF3 compared to Br-Cell3 precipitates indicated that Br-CNF3 in supernatant represented the more Br esterified fraction (70.9%) whereas the less Br esterified could be disintegrated by ultrasonication and remained in the precipitate. The persistent cellulose crystalline peak (1430 cm⁻¹) in both Br-Cell and Br-CNFs suggested that the bulk of cellulose crystalline domains was not affected by esterification and ultrasonication. The lowered intensity of the absorbed moisture peak (1632 cm⁻¹) for the highly esterified Br-Cell4 was also expected. Furthermore, weaker hydrogen bonding O-H stretching peak (3100-3800 cm⁻¹) in all Br-Cells than underivatized cellulose supported the successful cellulose hydroxyl conversion to bromine esters. The reduced hydrogen bonding interactions between cellulose chains could also aid the opening of (110) or (1-10) planes in Br-cell via ultrasonication to generate more Br-NCs.

With increasing Br-esterification levels, moisture absorption of Br-Cell reduced from 6.08% to 0.02% (FIG. 4B) which was consistent with effect of converting hydrophilic hydroxyls to Br-ester (FIG. 4A). The underivatized cellulose was stable at up to 260° C. and rapidly lost significant mass to give 2.6% char at 500° C. With the increase of Br content from 0 to 8.7 mmol/g, both the onset and max degradation temperatures lowered for Br-Cell1, 2 and 3, then slightly increased for Br-Cell4 (FIG. 4C). The lowered onset and max degradation temperatures may be due to the insertion of less thermal stable bromine esters; while the opposite increasing onset and max degradation temperatures of Br-Cell4 may be explained by the highly substituted alkyl bromines behaved as vapor-phase flame-retardant moieties to suppress decomposition of cellulose, a potential worthy of further study in the future. The significantly higher moisture contents of Br-CNF3 (8.5%) and Br-Cell3 precipitate (4.5%) than that of precursor Br-Cell3 (0.65%) gave evidence to generation of new hydrophilic surfaces due to the opening of cellulose (110) and (1-10) planes from ultrasonication. The lower onset and max degradation temperatures of Br-CNF3 (205 and 234° C.) than its precursor Br-Cell3 (219 and 241° C.) could be due to the three order of magnitude smaller fiber dimensions (4.7 nm thickness) and much higher specific surfaces.

### Degree of Substitution of Surface OH by Solution-State ¹H-NMR and Model Simulation

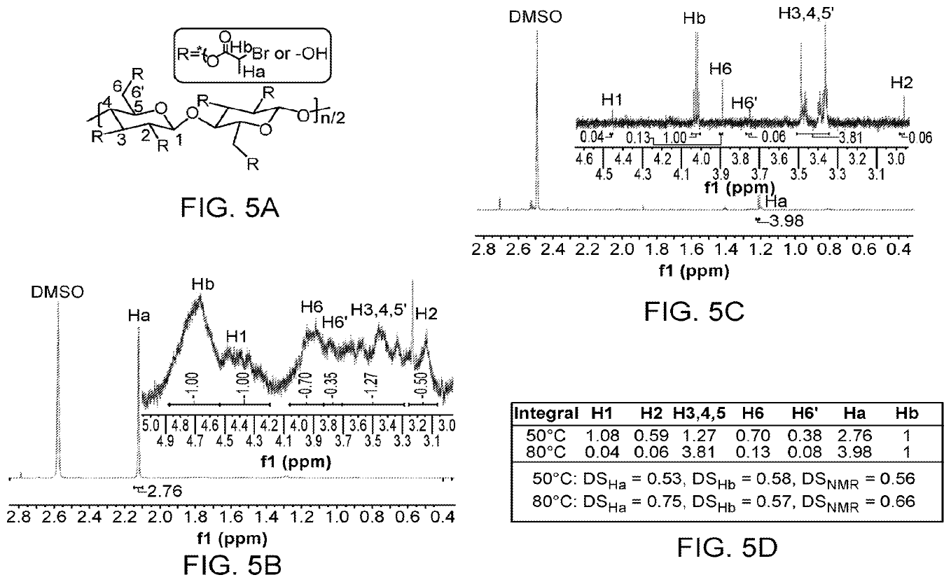

For solution-state ¹H NMR, Br-CNF3 was first solvent exchanged from DMF to acetone then to DMSO-4. The intermediate acetone exchange was repeated in three times by evaporation at either 50 or 80° C. to show cellulosic protons with characteristic methyl proton (Ha) or methylene proton (Hb) peaks of the alkyl bromide groups (FIG. 5A). For spectra of both Br-CNF (FIGS. 5B and SC), the furthest downfield peak at δ 4.20-4.52 and δ 4.53 are assigned to the cellulosic anomeric proton (H1) similar to the chemical shift at δ 4.5 reported in dissolved cellulose⁴⁵. The H6 and 116 peaks for 50° C. treated Br-CNF3 appeared at δ3.71-4.06 whereas two clear peaks appeared at δ 3.97 and δ 3.83 for 80° C. treated Br-CNF3 ( ). Both ranges were relatively downfield due to esters' de-shielding effect, but comparable to those in δ 3.65-3.88 range for dissolved MCC in NaOD/D₂O⁴⁶. Multiple overlapping peaks between δ 3.29-3.70 and δ 3.42-3.57 were assigned to H3, H4 and H5, matching those at δ 3.34-3.66 of TEMPO-CNF in D₂O⁴⁷. The furthest upfield cellulosic peak at δ 3.16 and δ 3.04 coincided with the chemical shift of H2 at δ 3.29 for cellulose/NaOD/D₂O⁴⁵ and δ 3.05 for cellulose dissolved in DMA-d₉/LiCl⁴⁸. Doublet methyl proton peaks (Ha) at δ 2.12 and δ 1.29 were both comparable to δ 1.6³⁷ of soluble Br-esterified cellulose. Most significantly, both doublet methyl (Ha) and quartet methylene proton (Hb) peaks at δ 4.53-4.87 and δ 4.11 indicated the successful insertion of alkyl bromine esters.

The degree of substitution of surface hydroxyls to alkyl bromines (DS_{NMR}) were quantified based on the assumption that all anomeric protons and all Ha and Hb protons of amorphous and crystalline surface AGUs of Br-CNF3 are detectable by ¹H NMR. The cellulose anomeric proton was the sum of the integrated areas for all anomeric H1 to H6′ proton peaks averaged by 7 then normalized by reference methylene proton Hb. Alkyl bromines could be estimated by integration of the areas of methyl Ha or methylene Hb divided by their respective 3 and 1 protons. The ratio of Br esterified C2, C3 and C6 OHs per surface AGU could be determined mathematically by the area ratio of alkyl bromine calculated from Ha or Hb over normalized anemic proton. Since each AGU has 3 OHs, DS_{Ha} and DS_{Hb}, representing the fraction of OH substituted by Br-ester determined by proton Ha or Hb, could be calculated by dividing ratio of Br esterified OHs per surface AGU by 3 according to eqn. (4) or (5).

$${D}_{Ha} = \frac{1}{3} \times \frac{integral of methyl protons ( Ha , doublet ) / 3}{\text{?} integral of anomeric protons \text{?}} \qquad ( 4 )$$

$${DS}_{Hb} = \frac{1}{3} \times \frac{integral of methylene protons ( Hb , quartet )}{\text{?} integral of anomeric protons \text{?}} \qquad ( 5 )$$

$$\text{?} \text{indicates text missing or illegible when filed}$$

For Br-CNF3 prepared at 80° C., majority of Br-CNF3 were in the precipitates of DMSO-d₆ suspension after centrifugation and decanted, causing much lower proton signal compared to Br-CNF3 prepared at 50° C. (FIGS. 5B and SC). At 80° C., Br-CNFs may associate with each by potential endothermic⁴⁹ interfibrillar N-substitution between alkyl bromide and OHs to precipitate, leaving only small portion of dissolved cellulose in DMSO-d₆. Thus, 80° C. treated spectra showed more distinguishable anomic proton peaks with inconsistent 0.75 DS_{H}a and 0.57 DSHb or possibly less reliable 0.66 DS_{NMR} (FIG. 5D). Br-CNF prepared at 80° C. showed a relative upfield Ha proton peak at δ 1.29 compared to δ 2.12 at 50° C. to indicate the decreased do-shielding effect of alkyl bromine caused by releasing HBr at 80° C. In addition, the cellulose dissolution could also be observed from the significant lower integral values (FIG. 5B) of H1 (0.04), H2 (0.06), H6 (0.13) and H6′ (0.08) compared to H3,4,5 (3.81). In comparison, 0.53 DSHA and 0.58 DSHb calculated from 50° C. treated Br-CNF3 spectra within the 2a range of total 7.4% benchtop NMR uncertainty⁵⁰ were averaged to be 0.56 DS_{NMR}. In preparing Br-CNF3 in DMSO-d₆ for ¹H NMR, Br-CNF3 was first solvent exchanged from DMF to acetone where the more hydrophilic or less Br-esterified may be left in DMF, thus not included for ¹H NMR. Therefore, the 0.56 DS_{NMR} derived may represent the more hydrophobic or more highly Br esterified CNF, thus higher than the DS of overall Br-CNF3 population.

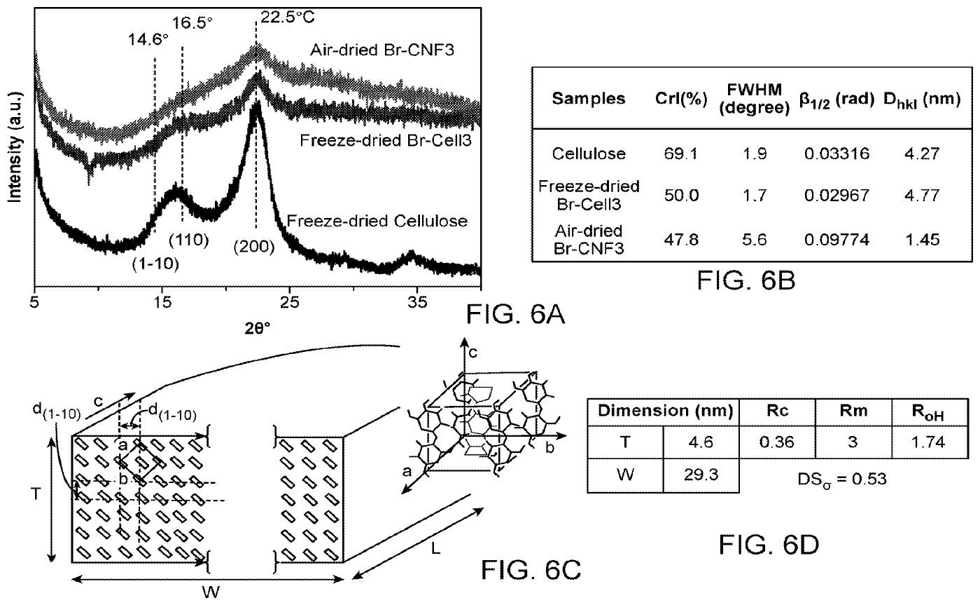

Both Br-Cell3 and Br-CNF3 displayed 20 peaks at 14.6, 16.5, and 22.5° corresponding to the respective (1-0), (110), and (200) monoclinic Iβ lattice planes of cellulose (FIG. 6A). The lowered 50.0% CrI of Br-Cell3 compared to original cellulose (69.1%) without size reduction gave evidence to bromine esterification of exposed cellulose chains on crystalline surfaces (FIG. 6B). The 47.8% CrI of Br-CNF3 was only very slightly lower than the 50.0% of Br-Cell3. The crystalline size of Br-CNF3 (1.45 nm), calculated via Scherrer eqn, (3), was only one third of Br-Cell (4.77 nm), indicating disintegration of crystalline regions in Br-Cell into smaller domains by ultrasonication without affecting overall crystallinity. The much higher absorbed moisture (8.5%) in Br-CNF3 than that in Br-Cell3 microfibers (0.65%) (FIG. 4B) also supported the notion that ultrasonication of Br-Cell3 may have opened up to cat additional hydrophilic surfaces on Br-CNF3.

A model representing the lateral cross-section of individual Br-CNF with hydrophilic (110) and (1-10) planes as surfaces was thus used (FIG. 6C), displaying thickness (T), width (W), and length (L) and the cellulose Iβ monoclinic unit cell dimensions along the (100) and (010) planes as a and b, respectively. The number of total cellulose chains Nₜ in the crystalline cross-section and the number of surface cellulose chains N, are expressed respectively as

$${N}_{t} = ( \frac{T}{{d}_{1 , 10}} + 1 ) ( \frac{W}{{d}_{1 - 10}} + 1 ) \qquad ( 6 )$$

$${N}_{s} = 2 ( ( \frac{T}{{d}_{110}} + 1 ) + ( \frac{W}{{d}_{1 - 10}} + 1 ) ) - 4 = 2 ( \frac{T}{{d}_{110}} + \frac{W}{{d}_{1 - 10}} ) \qquad ( 7 )$$

where “2” is for the two width and thickness sides; “−4” is for the four double counted corner chains; d₁₁₀ and d₁₋₁₀ are d-spacings of (110) and (1-10) planes. Since only hair of the crystalline surface chains, or only 1.5 OHs per crystalline surface AGU would expose, the ratio of crystalline surface OHs per AGU (Rc) is

$$Rc = \text{?} \qquad ( 8 )$$

$$\text{?} \text{indicates text missing or illegible when filed}$$

Both amorphous and crystalline surfaces OHs should be counted as part of CNF surface OHs. Since all OHs in amorphous regions are exposed, the amorphous OHs per AGU (Rm) is 3 OHs/AGU. The ratio of total available OHs per AG (R_{OH}) is the weight average of those on the crystalline surfaces (Re) and on amorphous region (Rm)expressed as

$${R}_{OH} = Rc \times Crl + Rm \times ( 1 - Crl ) \qquad ( 9 )$$

where the crystallinity CrI of Br-CNF3 is 0.478 (FIG. 6B). The degree of substitution (DS_{σ}) or mol % surface OHs esterified is as follows

$${DS}_{σ} = \frac{σ \times {mw}_{AGU}}{{R}_{OH}} \qquad ( 10 )$$

where σ is 5.7 mmol/g for both BrCell3 and Br-CNF3 and mw_{AGU} is the molecule mass of AGU (0.162 g/mmol). The d spacings were calculated according to the Bragg's law using 16.5° and 14.6° 2θ peaks derived from deconvolution of cellulose XRD spectra to be 0.534 and 0.606 am for d₁₁₀ and d₁₋₁₀, respectively. Using the measured 4.7 nm T and 29.3 nm W values, the ratio of crystalline surface OHs Rc and the ratio of total available OHs R_{OH} were calculated to be 0.36 OHs/AGU and 1.74 OHs/AGU, respectively. The DS_{σ} was determined to be 0.53 by eqn. (10) (FIG. 6D). Using the overall Br content of 5.7 mmol/g for both the precursor Br-Cell3 and Br-CNF3 may underestimated DS_{Q} of Br-CNF in the supernatant whereas the less substituted fraction is likely the micro-size cellulose in the precipitates. Nevertheless, the potential overestimated 0.56 DS_{NMR} and underestimated 0.53DS_{σ} showed good consistency to conclude that the actual DS to be between 0.53 and 0.56. The reliability of the solvent-exchanging method to prepare Br-CNF for ¹H NMR and the cross-sectional model with hydrophilic plane surfaces were both validated.

### Interfacial and Surface Properties of Br-CNF3

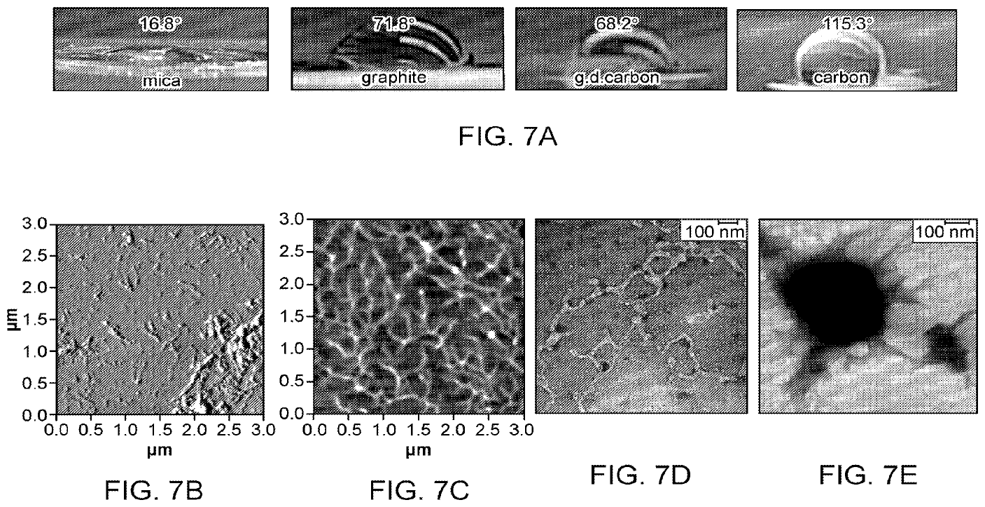

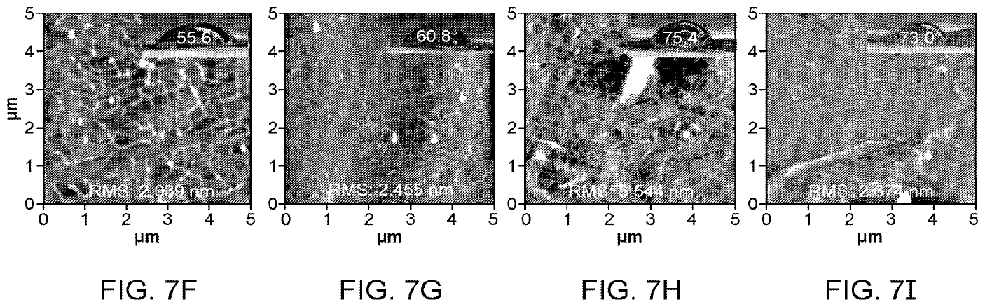

The interfacial interactions among Br-CNF3 and four substrates with varied hydrophilicity/hydrophobicity in a range of concentrations (0.0005 to 0.01 w/v %) were observed. The substrates using in AFM and TEM imaging and their water contact angles (WCAs) were mica (16.8°), freshly exfoliated graphite (71.8°), glow discharged carbon grid (68.2°), and carbon grid (115.3°)(FIG. 7A). On hydrophilic mica, most Br-CNF3 appeared as either loosely or extensively agglomerated short fibrils in 1.2 nm average thickness (FIG. 7B), On the moderately hydrophobic graphite and glow discharged carbon grid, inter-connecting fibrillar network was prevalent (FIGS. 7C and 7D) as noted earlier (FIGS. 3A and 3B) whereas only large NPs were observed on the hydrophobic carbon grid (FIG. 7E). These observations indicated Br-CNF3 in the supernatant were mostly moderately hydrophobic with better compatibility to graphite and glow discharged carbon, appearing as 4.6 nm thick and 29.3 nm wide fibrils. Meanwhile some Br-CNF3 were sufficiently hydrophilic to be partially dispersed as thin fibrils on mica while none was as hydrophobic as carbon. Both higher moisture absorption of Br-CNF3 than Br-Cell3 (FIG. 4B) and thinner hydrophilic CNFs (FIG. 7B) are consistent with the opening of hydrophilic (110) planes as new surfaces from ultrasonication of Br-cell into Br-CNF. These observations also further supported the hydrophilic model for Br-CNF (FIG. 5C). Moreover, the presence of Br-CNF as large NPs on carbon grid may be due to their aggregation via hydrogen bonding of surface OHs and dipole-diploe interactions of newly surface functionalized esters.

With increasing Br-CNF3 concentrations from 0.0005 to 0.01 w/v %, WCAs on Br-CNF3 deposited graphite increased from 55.6° to 73.0° (FIGS. 7F-7I). Br-CNF3 appeared as inter-connecting fibrils at the lower 0.0005 and 0.001 w/v % and as entangled fibrillar networks with few particulates at higher 0.005 and 0.01 w/v %. The initial deposition of 0.0005 w/v % Br-CNF3 dispersion partially covered the graphite to increase its hydrophilicity, lowering WCA from 71.8° (FIG. 7B) to 55.6° (FIG. 7F). The hydrophilicity decreased slightly with increasingly coverage at 0.001 w/v % (60.8° WCA) and further when nearly full coverage at 0.005 w/v % (75.4° WCA) (FIG. 7K), with slightly increased surface roughness. Further increased Br-CNF3 to 0.01 w/v % did not alter WCA, but slightly reduced the surface roughness as expected with fuller coverage. Therefore, diluted Br-CNF3 deposited at concentrations from 0.0005 to 0.01 w/v % is capable of monolayer to few layers to alter surface wettability and may be used in potentially surface coating and super-thin film applications.

### Dispersing Behaviors and Rheology of Br-CNF3

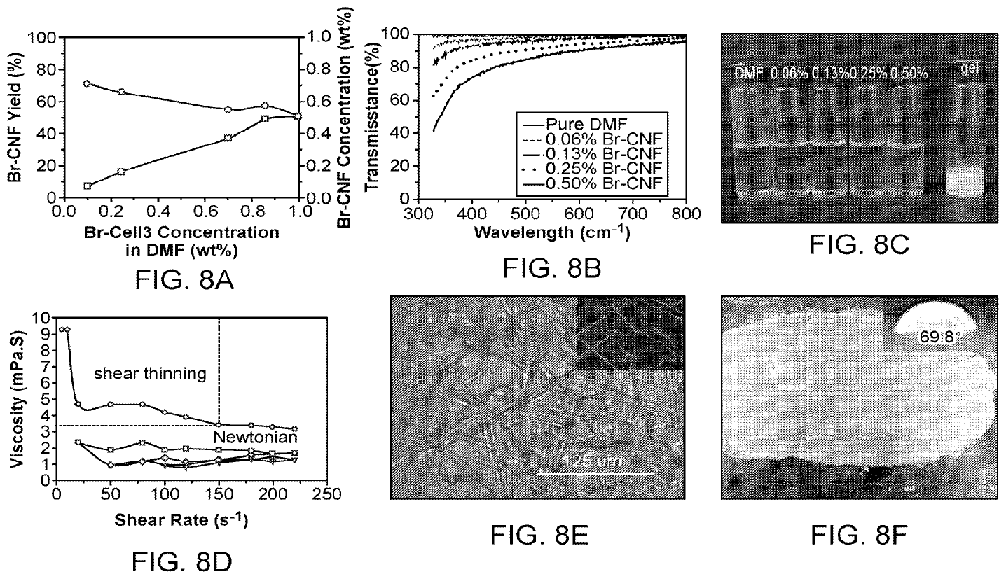

Dispersing behaviors of Br-CNF3 and their corresponding rheology at higher concentrations were investigated for additional potential formulation and application. First, disintegration of Br-Cell13 in DMF by ultrasonication (50%, 30 min) was scaled up from 0.1 to 1.0 w/v % or ten times. With increasing Br-Cell3 quantities, the resulting Br-CNF3 concentrations in the supernatants increased from 0.07 to 0.5 w/v %, while the Br-Cell3 to Br-CNF3 conversion or the yield reduced from 70.9 to 50.7% (FIG. 8A). All Br-CNF dispersions up to 0.5 w/v % appeared relatively transparent (FIGS. 8B and 8C). The Br-CNF dispersions from 0.06 to 0.25 w/v % exhibited Newtonian behaviors, i.e., their viscosities were independent of shear rates (FIG. 8D). At 0.5 w/v %, Br-CNF3 dispersion exhibited a shear thinning region at low shear rates below 150 s⁻¹ and a Newtonian region above. This implied that strong inter-fibrillar interaction of Br-CNF3 at 0.5 w/v % leads to higher viscosity in the low shear region below 150 s⁻¹. With increasing shear rates, fibrillar Br-CNF3 became more oriented in the direction of shear flow until reached the Newtonian region. The highest concentration that Br-CNF3 can be directly and homogeneously dispersed into DMF was 0.5 w/v %, above which Br-CNF3 formed gels that contained crystalline micro-fibers (FIG. 8E). Br-CNF3 (0.5 w/v %) DMF dispersion was further concentrated to 2.5 w/v % gel by evaporation (ambient temperature, 4 d), then blade coated as 1 mm thick gel on glass and air-dried overnight to ca. 100 μm thick film. The WCA of the coated Br-CNF3 film was 69.8° (FIG. 8F), close to the WCAs of thin layers deposited from 0.005 w/v % (75.4°, FIG. 7H) and 0.01 w/v % (73.0°, FIG. 7I). Similar WCAs for thin layers and thick blade coated film implied the organization of Br-CNF3 on these surfaces to be independent of thickness from several nm to one hundred μm and may applied as hydrophobic coating in either manner. Furthermore, the coated thin film had an impressively high modulus of 198 MPa, as well as 6.7 MPa tensile stress and 10.7% strain-to-failure. Therefore, not only the Br-CNF3 dispersion's shear-thinning behavior above 0.5 w/v % demonstrate its potential as a rheology modifier in organic formulation, but the ultra-high modulus and strength of its thin film also present its potential as strength enhancement additive in coating and film applications.

### Conclusions

This study proofs the concept for facile one-pot functionalization of cellulose and direct disintegration of functionalized cellulose by ultrasonication in organic liquids into hydrophobic nanocelluloses. Organic compatible Br-esterified cellulose nanofibrils (Br-CNFs) have been successfully synthesized via rationally designed bromine esterification of cellulose in DMF and direct ultrasonication. This bromine esterification-ultrasonication approach can be tuned to product either Br-CNFs or Br-NPs efficiently. The optimally esterified Br-Cell3 (5:1 BPB:AGU ratio, 23° C., 6 h) contained 5.7 mmol/g Br esters to be disintegrated by ultrasonication (50% amplitude, 30 min) to yield 70.9% Br-CNF3 in average 4.6 nm thickness, 29.3 nm width, up to 1 μm length, and 47.8% crystallinity. While Br esterification lowered the overall crystallinity (69.1% to 50.0%), ultrasonication reduced the crystalline size (from 4.77 nm to 1.45 nm) to expose new (110) and (1-10) hydrophilic planes in Br-CNF as evident by the increased moisture absorption (0.65% to 8.5%). The successful conversion of surface OHs to alkyl bromines was confirmed by the presence of C-O at 1740 cm⁻¹ in FTIR and chemical shifts for methyl proton (Ha) and methylene proton (Hb) at δ 2.12 and δ 4.53-4.87 in ¹H NMR, respectively. The degree of substitution was determined to be between the underestimated 0.53 DS_{σ} based on CrI and cross-sectional Br-CNF dimension model and the overestimated 0.56 DS_{NMR} from solution-state ¹H NMR. Br-CNF3 dispersions exhibited Newtonian behaviors at concentrations below and shear thinning behaviors at above 0.5 w/v % and could be homogeneously deposited as few nm ultra-thin layers to exhibit WCAs in the range of 73-75°. Moreover, blade coating of gel (2.5 w/v %) could also dried to one hundred μm thick hydrophobic (70° WCA) film, showing comparable hydrophobicity irrespective of thickness. All were similarly hydrophobic as cellulose acetates and polyesters. The shear-thinning behavior of Br-CNF dispersions demonstrate their potential application as viscosity modifiers in variety of mechanical fluids. The ultra-high modulus and strength film from gel coating further shows the potential for dual high-strength and hydrophobic applications.

### Example 5—2-Bromopropionyl Esterified Cellulose Nanofibrils as Chain Extender or Polyol in Stoichiometrically Optimized Syntheses of High Strength Polyurethanes

### Experimental

Materials. Cellulose was isolated Irvin rice straw (Calrose variety) by a previously reported three-step process of 2:1 v/v toluene/ethanol extraction, acidified NaClO₂ (1.4%, pH 3-4, 70° C., 5 h) delignification, and alkaline hemicellulose dissolution (5% KOH, 90° C., 2 h). 2-Bromopropionyl bromide (BPB, 97%, Alfa Aesar), 4-dimethylaminopyridine (DMAP, 99%, Acros Organics), polytetramethylene ether glycol (PTMEG, Mₙ:1,000 and 2,900 Da, Sigma Aldrich), methylene diisocyanate (MDI, 97%, Sigma Aldrich), 1,4-butanediol (1,4-BD, 99%, Alfa Aesar), N,N-dimethylformamide (DMF, certified grade, Fisher Scientific), and acetone (histological grade, Fisher Scientific) were used as received without further purification. All nanocellulose concentrations in DMF were denoted in weight/volume percent (w/v %) whereas all PU/CNF compositions were designated in weight/weight percent (w %).

Synthesis and Characterization of Br-CNFs. Br-CNFs were produced from rice straw cellulose by one-pot esterification with 2-bromopropionyl (5:1 BPB to anhydroglucose or AGU molar ratio, 23° C., 6 h) and in situ ultrasonication (Qsonica Q700, 50/60 Hz, 50% amplitude, 30 min) in DMF. For imaging by atomic force microscopy (AFM, Asylum-Research MFP-3D), Br-CNF DMF dispersion was diluted (10 μL, 0.0005 w/v %) and deposited on freshly cleaved highly oriented pyrophoric graphite (HOPG), then air-dried in fume hood for 6 h. The heights of Br-CNFs (n: 100) were profiled in the tapping mode with a 5 μm×5 μm seen size and a $12 Hz scan rate. For imaging by transmission electron microscopy (TEM, Philip CM12), Br-CNF dispersion (10 μL, 0.01%) was deposited onto glow-discharged carbon-coated TEM grids (300-mesh copper, Formvar-carbon, Ted Pella Inc., Redding, CA), blotted with a filter paper after 5 min to remove excess dispersion, negatively stained with aqueous uranyl acetate (2 w/v %) for 5 min, and blotted again to remove excess liquid. This staining-blotting process was repeated five times, dried under the ambient condition for 15 min, then imaged at a 100 kV accelerating voltage. The widths and lengths of over 100 Br-CNFs for each sample were calculated using ImageJ Analyzer (ImageJ, NIH, USA). Crystallinity and domain size of air-dried Br-CNF film were determined using X ray diffraction (XRD) as described previously.

The Br content of Br-CNF (σ_{Br}, mmol/g) was determined by the mass gain of 2-bromopropionyl esterified cellulose in which the C2, C3 and C6 OHs were converted to 2-bromopropionyl ester:

$${σ}_{Br} = \frac{{m}_{Br - cell} - {m}_{cell}}{135 \times {m}_{Br - cell}} \qquad ( 1 )$$

where m_{cell} is the initial cellulose mass (g), m_{Br-cell} is the dry mass (g) of 2-bromopropionyl esterified cellulose, and 135 (g/mol) is the molecular mass difference between 2-bromopropionyl ester and hydroxyl. The substitution of surface OHs to 2-bromopropionyl, described as fraction of converted OHs (p), was estimated via solution phase ¹H NMR (Bruker AVIII 800 MHz ¹H NMR spectrometer) following the previously established method briefly described in Supporting Information. Surface OH content (σ_{OH}, mmol/g) of Br-CNF was calculated by multiplying Br content (σ_{Br}, mmol/g) by available OH (1-ρ) then divided by converted OH (ρ):

$${σ}_{OH} = {σ}_{Br} \times \frac{1 - μ}{ρ} \qquad ( 2 )$$

Polyurethane Synthesis. The polyurethane control was prepared by dissolving MDI (1.90 mmol, 0.47 g) and PTMEG (Mₙ:2,900 Da, 0.86 mmol, 2.5 g) in DMF (20 mL), degassed (Branson 2510) for 1 min, purged with N₂ for 10 min, then reacted at 90° C. in an oil bath under stirring for 3 h to form prepolymer. Chain extender 1,4-BD (0.86 mmol, 0.078 g) was added to react at 90° C. for another 3 h, then quenched in ice bath to end the reaction.

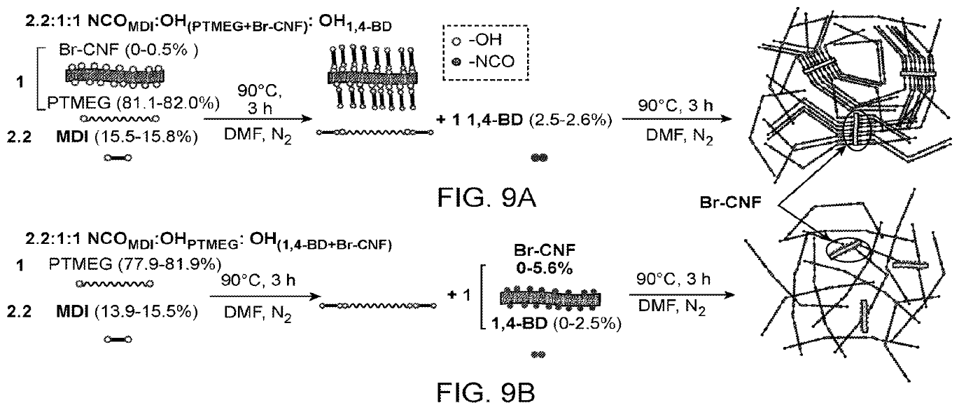

Br-CNF as Extender. To prepare PU/CNF composites using Br-CNF as part of extender at a fixed 2.2:1:1 NCO_{MDI}:OH_{PTMEG}:OH_{1,4-BD+Br-CMF} molar ratio (FIG. 9A), PTMEG (Mₙ:2.900 Da, 1.72 mmol OHs, 2.5 g) was reacted with MDI (3.80 mmol NCOs, 0.47 g) in 15 mL DMF, degassed (Branson 2510) for 1 min, purged with N₂ for 10 min, then sealed and heated to 90° C. with stirring for 3 h to form prepolymer. Br-CNF (0.5 w/v % in DMF) was added at 1.8 or 5.4 w %, i.e., 11 mL or 35 mL (0.19 and 0.61 mmol available OHs), to pre-dissolved 1,4-BD (0,069 and 0.051 g, 1.54 and 1.12 mmol OHs), degassed for 1 min, then to the prepolymer under constant stirring at 90° C. for another 3 h, finally quenched in ice bath to stop the reaction. Without any 1,4-BD, PU/CNF with Br-CNF (0.5 w/v %, 0.61 mmol available OHs, 35 mL) as the lone extender was also synthesized at a fixed 2.2:1:0.35 NCO_{MDI}:OH_{PTMEG}:OH_{Br-CNF} molar ratio for comparison.

Br-CNF as Polyol. The PU/CNF composites with Br-CNF serving in the role as polyol (FIG. 9B) were prepared at varying Br-CNF contents (0-0.5 w %) at a fixed 2.2:1:1 NCO_{MDI}:OH_{PTMEG+Br-CNF}:OH_{1,4-BD} dispersions were diluted with DMF to 20 mL in 0.0075, 0,015, 0.03, 0.045, and 0.075 w/v %, degassed (Branson 2510) for 1 min and purged N₂ for 10 min. PTMEG (Mn:2,900 D, 1.72 mmol OHs, 2.5 g) and MDI (3.8-3.92 mmol NCOs, 0.47-0.49 g) were added into each dispersion in high vacuum silicone grease scaled 50 mL round bottom flask at 90° C. oil bath under stirring to react for 3 h to form prepolymer. 1,4-BD (0.86 mmol, 0.078 g) was added to reacted for another 3 h, then quenched to end reaction. Reactions were repeated with 1.8 mL Br-CNF (0.5 w/v %) at 2.1:1:1 and 2:1:1 NCO_{MDI}:OH_{PTMEG+Br-CNF}:OH_{1,4-BD} molar ratios to investigate excess MDI effects. Lower molecular weight PTMEG (Mₙ:1,000 Da) was used with 1.8 mL Br-CNF (0.5 w/v %) at 2.2:1:1 NCO_{MDI}:OH_{PTMEG+Br-CNF}:OH_{1,4-BD} molar ratio. Films were cast from various viscous reaction mixtures of various PU/CNF compositions as well as Br-CNF alone in glass petri dishes and dried at 60° C. oven for 2 d. Volume of circular films were calculated from thickness and diameter measured by micrometers and graduated scale to estimate densities.

Characterization of PU/CNF film. The morphology of PU/CNF film was imaged by optical microscopy (Leica DM2500) in transmission mode and under cross-polars. For attenuated total reflectance (ATR) Fourier transformed infrared spectroscopy, each PU film was scanned by Thermo Nicolet 6700 spectrometer under ambient conditions from an accumulation of 128 scans at a 4 cm⁻¹ resolution from 4000 to 400 cm⁻¹. To determine glass transition (T_{g}) and melting (Tₘ) temperatures of PU/CNF film, each ca. 10 mg sample was cooled by liquid nitrogen to −100° C. and scanned at 10° C./min to 50° C. by differential scanning calorimetry (DSC, DSC-60 Shimadzu). The tensile properties of films (40×14×0.4 mm) were measured using an Instron 5566 tensile tester with a static 5 kN load cell, ca. 20 mm gauge length and 20 mm/min crosshead speed to break and to 400% strain in cyclic mode. For each data point, at least three films were tested with the average value and standard deviation reported. The modulus was determined by the initial slope of strain-stress curve. Engineering stress (a) was calculated from F/A₀, where F was applied load (N) and A₀ is the initial cross-sectional area (m³). Engineering strain (ε) was calculated by ΔL/L₀, where ΔL was the extension (mm) of the sample and L₀ was initial sample gauge length (mm).

### Results and Discussion

Characteristics of Br-CNFs. Br-CNFs were optimally synthesized by one-pot 2-bromopropionyl esterification of rice straw cellulose (5:1 BPB to AGU molar ratio, 23° C., 6 h) and in situ ultrasonication (50% amplitude, 30 min) in DMF to be ribbon-like with 4.6±1.8 nm thickness (T), 29.3±9.2 nm width (W), and ca. 1 μm length (L). The Br-CNF geometries are uniquely anisotropic, showing over 6 W/T and 213 L/T ratios. 2-bromopropionyl esterification converts the OHs in the less ordered region of cellulose to 2-bromopropionyl esters to endow organic compatibility and to facilitate the direct disintegration by ultrasonication of 2-bromopropionyl esterified cellulose into homogeneously dispersed Br-CNFs, all in the same organic media DMF. The level of substitution (p) quantified by ¹H NMR was 0.48, showing nearly half of the surface OHs were converted to 2-bromopropionyl esters. The remaining 52% surface OHs, equivalent to 3.5 mmol OHs/g Br-CNF by eqn. (2), remained available to react with MDI (Table 1). The XRD of Br-CNFs displayed 20 peaks at 14.6, 16.5, and 22.5°, corresponding to the respective (1-10) (110) (200) monoclinic Iβ lattice planes of cellulose. The 0.48 CrI of Br-CNF showed retention of 69% crystallinity of the original cellulose (CrI:0.69).

TABLE 1
CNF Characteristics: dimensions, crystallinity, Br content/degree
of substitution, available OHs content.

| | | | Crystallite | | Br | | OHs |
|---|---|---|---|---|---|---|---|
| Thickness | Width | Length | Dimension | | content | Level of | content |
| (nm) | (nm) | (nm) | (nm) | CrI | (mmol/g) | substitution | (mmol/g) |
| 4.6 | 29.3 | ca. 1000 | 1.45 | 0.48 | 3.2 | 0.48 | 3.5 |

Br-CNFs have similar in thickness (T=4.6 nm) as another highly hydrophobic ODE-CNF (T=4.4 nm, W=4.1 nm, L=1.7 μm), both are thicker than hydrophilic TEMPO-CNF (T=1.5 nm, W=2.1 nm, up to 1 μm long), all ca/1 μm or longer and derived from the same rice straw cellulose. Br-CNF (W=29.3 urn) is, however, considerably wider than those respective ODE-CNF and TEMPO-CNF, i.e., by 7 and 14 times. The 6 W/T ratio of the cross-section gives Br-CNF highly anisotropic lateral dimensions than the near isotropic W/T ratios of ODE-CNF and TEMPO-CNF, both the latter two disintegrated by high-speed blending in water. These lateral dimensional and aspect ratio differences indicated the specific ultrasonication applied to be less intensive to disintegrate 2-bromopropionyl esterified cellulose in the less ordered domains into CNFs compared to aqueous high-speed blending of either hydrophobic ODE-cellulose or hydrophilic TEMPO-cellulose. Br-CNFs (CrI:0.48) is slightly less crystalline than ODE-CNF (CrI:0.52) but clearly less crystalline than TEMPO-CNF (CrI:0.63). The reduced crystallinity of Br-CNF was attributed mainly to the chemical reaction of cellulose, i.e., 2-bromopropionyl esterification reduced crystallinity of cellulose (CrI:0.69) to Br-cell (CrI:0.50) to signify the more robust 2-bromopropionyl esterification in DMF in comparison to lesser effects on crystallinity from the less intensive telomerization or TEMPO-oxidation. The significantly retained crystallinity (CrI:0.48) and largely available surface OHs (3.5 mmol/g) made Br-CNF uniquely surface-reactive polyols with crystalline core as potential covalent bonded reinforcement in TPU synthesis.

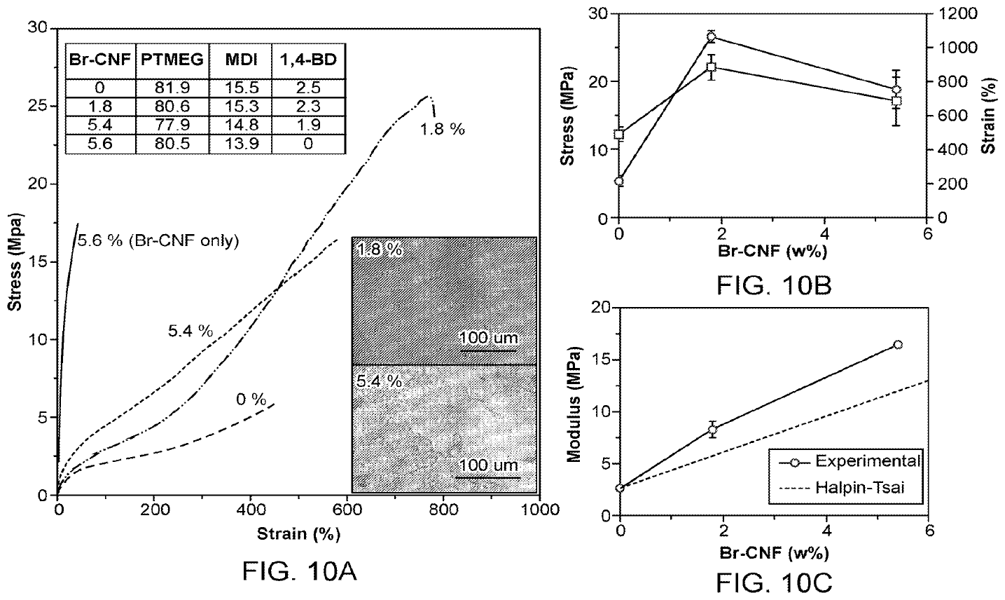

Br-CNF as chain extender in PU synthesis at 2.2:1:1 NCO:OH:OH. Br-CNF was incorporated as chain extender to partially replace 11 and 35 mol % OH in 1,4-BD or 1.8 and 5.4 w % Br-CNF in PU syntheses at a fixed 2.2:1:1 NCO_{MDI}:OH_{PTMEG}:OH_{1,4-BD+Br-CNF} molar ratio (FIG. 9A, FIG. 10A-10C). Br-CNF was also incorporated as the only chain extender at 5.6 w %, equivalent to 35 mol % OHs of 1,4-BD, for comparison. Upon replacing 11 mol % OHs of 1,4-BD with 1.8 w % Br-CNF (FIGS. 10B and 10C), the elastic modulus, tensile strength and strain-to-failure significantly increased from 2.6 to 8.3 MPa, 5.4 to 26.7 MPa and 490 to 883%, respectively. Replacing over three times of 1,4-BD OHs (35 mol %) with Br-CNF (5.4 w %) further doubled the modulus to 16.5 MPa but lowered the strength by 30% to 18.8 MPa and stain by 22% to 684%. The enhanced elastic modulus and tensile stress were attributed to linking the MDI-capped soft segments with multiple OHs of Br-CNF like crosslinkers, instead of the short 4-C extender. The increased strain-to-failure was attributed to the strengthened soft domains from hydrogen bonding between the remaining unreacted OH on Br-CNF and PTMEG. That modulus increase essentially linearly with Br-CNF contents further signifies the contribution of multiply crosslinked Br-CNF with MDI-capped soft segments. The more heterogeneous appearance of films with 5.4 w. Br-CNF suggest possible agglomeration and/or phase separation of Br-CNF to lead to lowered tensile stress and strain-to-failure (FIG. 10A). Furthermore, using 5.6 w % Br-CNF (equivalent to 35 mol % OHs of 1,4-BD) as the only extender, the modulus drastically increased from 16.5 to 173 MPa while the strain significantly reduced from 684 to 46%, but only slightly decreased tensile stress from 18.8 to 17.0 MPa. As the lone chain extender, 5.6 w % Br-CNF only provided 35 mol % OHs of 1,4-BD, insufficient to link all the MDI-capped soft segments to turn the elastomeric PU to high modulus plastic,

The Halpin-Tsai model that predicts the modulus of short fiber reinforced composites with perfectly aligned, homogeneously mixed, and constant fiber volume fraction in a continuous matrix was used to compare with the experimental values. The predicted modulus from the Halpin-Tsai model is expressed as

$$E = {E}_{m} ( \frac{1 + ζη {V}_{f}}{1 - η {V}_{f}} ) \qquad ( 3 )$$

$$η = \frac{{E}_{f} / {E}_{m} - 1}{{E}_{f} / {E}_{m} + ζ} \qquad ( 4 )$$

where E is the longitudinal modulus of the unidirectional composite; V_{f} is the fiber volume fraction based on mass fraction of Br-CNF in PU with their respective estimated densities of 1.2 g/cm³ and 1.1 g/cm³; Eₘ and E_{f} are the respective matrix and fiber modulus; is a shape factor for Br-CNF and defined as

$$ζ = {( 0.5 L / D )}^{1.} \qquad ( 5 )$$

where L is the 1 m length of Br-CNF and D is the diameter or the geometrical mean (11.7 nm) of Br-NF thickness (4.6 nm) and width (29.3 nm).

From Halpin-Tsai model simulation, elastic modulus for PU with 1.8% and 5.4% Br-CNF were 5.7 and 11.9 MPa, ca. 30% lower than the respective experimental values of 8.3 and 16.5 MPa. The higher experimental modulus than predicted by the Halpin-Tsai model supports the presence of new covalent bonding between Br-CNF and MDI when applied as extender. As a chain extender, the optimal Br-CNF content was 1.8 w % e to significantly improve all three tensile properties, i.e., to over 3 times in modulus, nearly 4 times in strength, and 80% increase in strain. Similarly, the overall toughness also reached highest at 1.8 w %.

### Br-CNF as Polyol in PU Synthesis

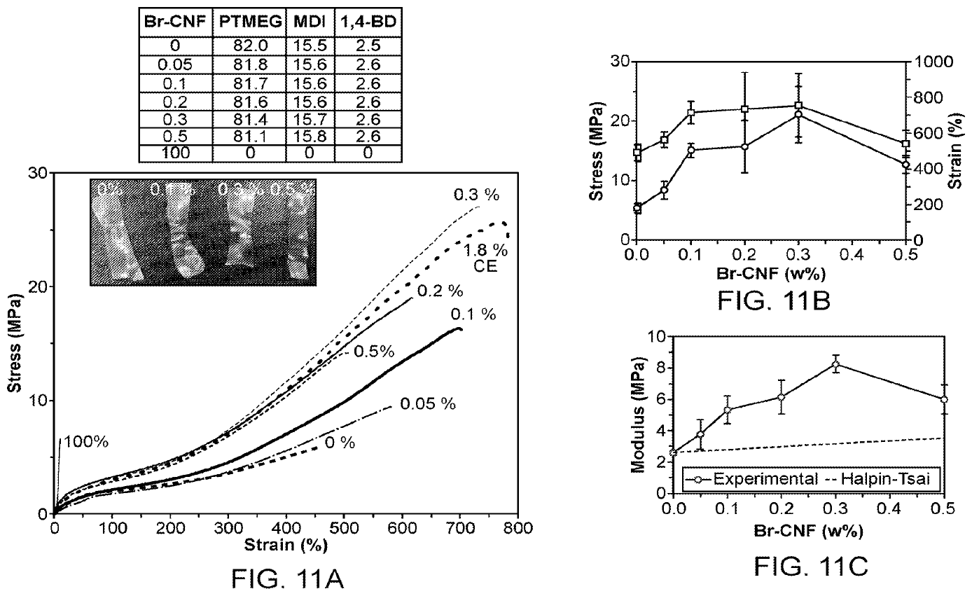

Br-CNF loading. Br-CNF with 3.5 mmol OHs/g was also used as polyol to replace 0.3, 0.6, 1.2, 1.8 and 3.1 mol % OHs of PTMEG diols to synthesize pre-polymer with 10 mol % excess of MDI, i.e., 2.2:1:1 NCO_{MDI}:OH_{PTMEG+Br-CNF}:OH_{1,4-BD} mole ratio, to ensure capping all Br-CNF surface OHs. These partial replacement of diol with Br-CNF polyol represent 0.05, 0.1, 0.2, 0.3, and 0.5 w % of Br-CNF in the PU/CNF composites. The colorless PU turned yellowish with increasing Br-CNF contents and into golden color with 0.5 w % Br-CNF (FIG. 11A). With up to 0.3 w % Br-CNF, the elastic modulus increased by over three times from 2.6 to 8.3 MPa and the tensile strength by nearly four times from 5.4 to 21.1 MPa, while the strain also increased by 54% from 490 to 755% (FIGS. 11B and 11C). However, with further increased Br-CNF content to 0.5 w %, all tensile modulus, strength, and strain reduced to respective 6.0 MPa, 15.7 MPa, and 539%, i.e., levels near or below those with 0.1 w % Br-CNF. The increases in all three mechanical properties were attributed to improved dispersion due to 2-bromopropionyl esters functionalized Br-CNF surfaces and covalent bonding between Br-CNF surface OHs and MDI. The outstanding reinforcement effects on modulus and tensile strength were attributed to the crystalline core of Br-CNF and surface OHs covalent bonded with MDI, serving as additional and new kind of hard segments. Meanwhile replacing diol with Br-CNF polyol in the soft segments could also enhance hydrogen bonding interactions between unreacted Br-CNF surface OHs and PTMEG to increase stretchability. In addition, the ability of Br-CNF to realign along the loading direction may be another reason for increased tensile strength and stretchability. Thai much reduced tensile stress, strain-to-failure and elastic modulus with 0.5 w % Br-CNF may be due to inter Br-CNF association, reducing their reaction with MDI and hydrogen bonding with PTMEG, Comparably, all experimental elastic modulus values of PU with Br-CNF as polyol were over two times or higher than Halpin-Tsai model simulated values (FIG. 11C), indicating the extreme effectiveness of strong covalent bonding between Br-CNF and MDI.

This observation illustrated surface OHs on Br-CNF are more reactive to free MDI as polyol but less accessible to MDI-capped PTMEG prepolymer as chain extender. In fact, the same modulus 8.3 MPa was achieved with Br-CNF serving as either polyol or chain extender, but requiring only one sixth in the polyol role (0.3 w %) than the chain extender (1.8 w %). The optimal molar replacement of Br-CNF_{hydrolysis for these in} PTMEG soft segment or 1,4-BD chain extenders was 1.8 or 11 mol %, respectively.

These findings show, for the first time, that a mere 0.3 w % Br-CNF quantity can significantly enhance the tensile modulus (3.2×) and strength (3.9×) while also improve the strain-to-failure (1.5×), In all prior work of involving cellulose or nanocellulose either as filler or in PU synthesis, improvement in all three tensile properties was only reported in three, i.e., 5 w % MCC, 1 w % MFC, and sonication assisted 1 w % CNC, all with the shorter PTMEG (Mₙ:1,000 Da) (Table 1). While those PUs synthesized with the commonly used shorter PTMEG is expected to have higher modulus but reduced strain, the MDI quantities were also double. Among them, only two documented FTIR evidence of new covalent bonding formation between MFC or CNC and isocyanates. Furthermore, Br-CNF is homogeneously dispersed in DMF without any pretreatment nor shear force mixing, a stark contrast to the extra and necessary processes of freeze-drying³², solvent exchange^{33,34} then aided by homogenization³¹, or soniction³²⁻³⁴, to disperse hydrophilic nanocelluloses. Uniquely, Br-CNF is not only efficiently synthesized, i.e., one-pot esterification and in situ disintegration, directly from cellulose, but also robust in reactivity to serve dual roles as either polyol or chain extender in the synthesis of PU. Most significantly, the quantity of the toxic MDI was significantly reduced to half.

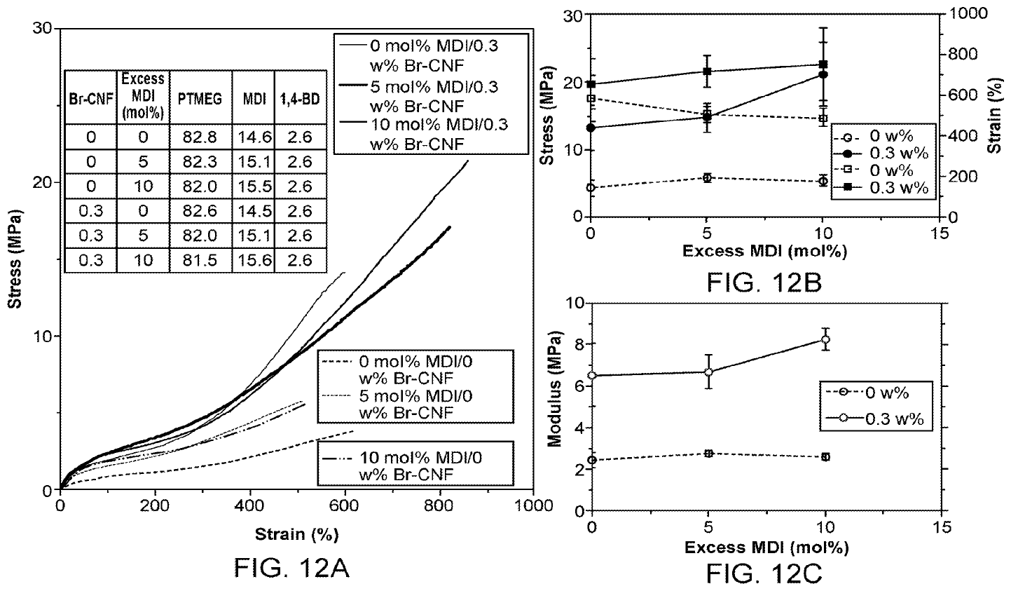

MDI optimization. In the attempt to further reduce the diisocyanate quantity, the molar excess MDI was reduced from 10 to 0 mol % in the synthesis of prepolymer with 0.3 w % Br-CNF as polyol replacing 1.8 mol % PTMEG hydroxyls (FIG. 12A). Generally, both modulus and tensile strength displayed positive correlation to excess MDI mol % meanwhile negative correlation was observed for strain-to-failure (FIGS. 12B and 12C). In the absence of Br-CNF, both elastic modulus and tensile stress of the PU control slightly increased from 2.5 to 2.8 MPa and 4.3 to 5.8 MPa, whereas strain-to-failure slightly decreased from 585 to 507% with 5 mol % excess MDI, but showing no further change with 10 mol % excess MDI, indicating 5 mol % excess MDI to be adequate to cap PTMEG diols in the synthesis of PU. With 0.3 w % Br-CNF, all three tensile modulus, stress, and strain-to-failure moderately increased from 6.5 to 8.3 MPa, 13.2 to 21.1 MPa and 656 to 755% with the increase of excess MDI to 10 mol %. More excess MDI required with Br-CNF than the control suggested that surface OHs on Br-CNF may be less accessible than those of the PTMEG diol. It is also possible that surface Br esters determined by ¹H NMR may be over-estimated due to the DMF-to-acetone solvent exchange preparation that left out some less substituted Br-cellulose, leading to underestimated OHs content of Br-CNF. Further increasing Br-CNF content from 0.3 to 1 w % w/o excess MDI moderately increased strength (1.2×) and strain-to-failure (1.2×) but sacrificed 20% elastic modulus. The optimal Br-CNF as polyol w/o excess MDI was determined to be 1 w %, nearly 3-time higher than optimal 0.3 w % Br-CNF content at 10 mol % excess MDI. Thus, 10 mol % excess MDI not only further enhance the tensile properties of PU/CNF composite but also requiring significantly less Br-CNF. Unlike prior PU synthesized with a constant 2:1 NCO_{MDI}:OH_{PTMEG} ratio without consideration of cellulose OHs, this work rationally targets the OHs of both Br-CNF polyol and PTMEG diol stoichiometrically to isocyanate to significantly improve all tensile properties of PU, i.e., 3.2× modulus and 3.9× strength and 1.5× strain-to-failure, with a mere 0.3 w % Br-CNF as polyol and 10 mol % excess MDI.

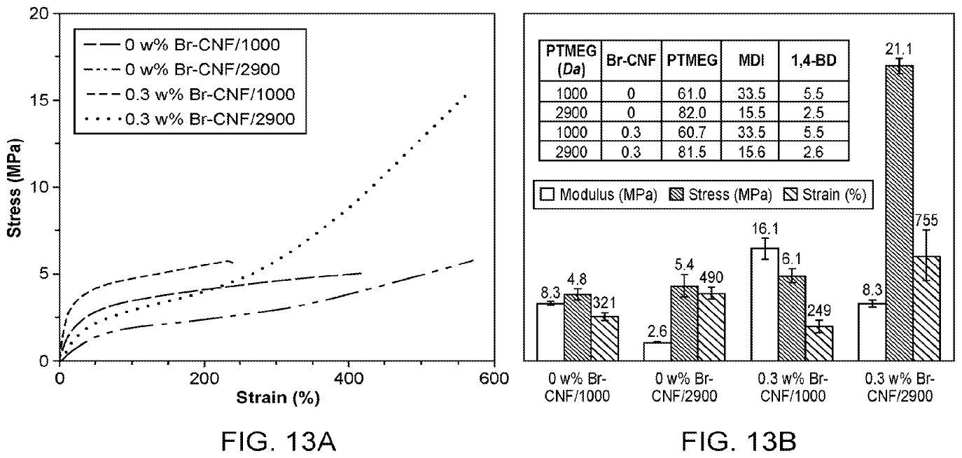

PTMEG chain length. While using longer PTMEG (Mₙ: 2,900 Da) than the commonly reported shorter PTMEG (Mₙ:1,000 Da) has the advantage of reducing MDT usage, lower elastic modulus and higher strain of PU are expected and was confirmed by the control PU synthesized without Br-CNF (FIG. 13A). With the optimal 0.3 w % Br-CNF as polyol and 10 mol % excess MDI, the elastic modulus nearly doubled from 8.3 to 16.1 MPa while strength and strain modestly increased and decreased, respectively for the shorter PTMEG, while in contrast, the modulus increased from 2.6 to 8.3 MPa by over three times, stress nearly quadruple from 5.4 to 21.1 MPa, and strain nearly doubled from 490 to 755% with the nearly three times longer PTMEG (FIG. 13B). Therefore, while incorporating 0.3 w % Br-CNF as polyol most significantly improved the modulus of PU with shorter PTMEG, the effect on PU with the longer PTMEG was significant in all three tensile properties. The more significant reinforcement effects of Br-CNF on PU synthesized with longer PTMEG (Mₙ:2,900 Da) support the notion that both covalent bonding between Br-CNF and MDI and hydrogen bonding between B-CNF and PTMEG were maximized to give the best mechanical performance. Also, adding 0.3 w % Br-CNF as polyol would minimize negative effects of the longer PTMEG on the modulus to retain same modulus (8.3 MPa) as short PTMEG (M:1000 Da),

While the optimal 1.8 w % Br-CNF as extender led to 27% higher tensile strength (26.7 vs 21.1 MPa), 17% higher strain-to-failure (883 vs 755%), and same elastic modulus (8.3 MPa) than its role as polyol, the slight strength enhancement with six times of Br-CNF is indicative of the more efficient covalent bonding of Br-CNF with MDI as polyol than as chain extender. With similar PTMEG, MDI and 1,4-BD contents, 0.3 w % Br-CNF as polyol capped by 10 mol % excess MDI with PTMEG (Mₙ: 2,900 Da) were optimal to produce the most significantly reinforced PU film with 3.2× modulus, 3.9× strength and 1.5× strain-to-failure meanwhile reducing MDI usage to 15.7 w %.

Lastly, ethylene glycol (EG) was used to replace 1,3-BD to improve diffusion while also stiffen the diol-MDI-diol hard segments for potential further strength enhancement. In addition, Br-CNF was used to replace both PTMEG and EG chain extender OHs at the optimal 1.8 mol % and 11 mol %, respectively. The tensile strength of PU with Br-CNF in both roles did not produce any synergistic or even additive effect. At a total 2.1% mass content, Br-CNF may have agglomerated to heterogeneously phase separate to impede their covalent bonding with MDI and/or hydrogen bonding with each other. Therefore, optimal reinforcing effect of Br-CNF requires a balance of achieving maximal covalent bonding to MDI as well as maximal hydrogen bonding with PTMEG.

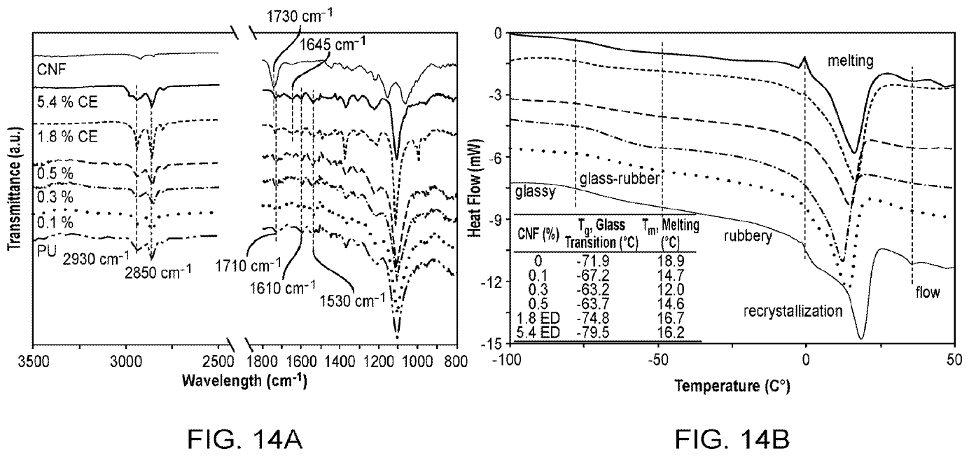

ATR and DSC spectra of PU/CNF composites. The presence of urethane link in PU and PU/CNF composite films were clearly evident in their ATR spectra (FIG. 14A), showing C═O peaks at 1709 cm (hydrogen bonded) and 1730 cm⁻¹ (free), C—N asymmetric stretching peak at 1610 cm⁻¹, and N—H bending peak at 1530 cm⁻¹. For films with 1.8 and 5.4 w % Br-CNF as chain extender, the detection of a new carbonyl peak at 1645 cm⁻¹ gave evidence to the reaction between the Br-CNF surface OHs with MDI. In those with Br-CNF as polyol, however, no new peak was observed due to the extremely low quantities up to 0.5 w %. The effects of Br-CNF from covalent bonding with MDI, either as polyol or chain extender, as well as their interactions with the soft segments were further elucidated by their thermal behaviors (FIG. 14B). Glass transition temperature T_{g} (° C.) increased from −71.9° C. to −63.7° C. with increasing 0 to 0.5 w % Br-CNF polyol, but decreased to −79.5° C. with increasing 0 to 5.4 w % Br-CNF extender. The endothermic recrystallization peak for MDI-1,4-BD-MDI hard domains remained constant at −1.5° C. and independent of Br-CNF contents and roles, indicative of no Br-CNF effects on original PU hard domain size and distribution. As polyol, the effective reaction between Dr-CNF and MDI introduces new Br-CNF-MDI carrying polyisocyanate terminals among the diols, also bearing isocyanate terminals, to reduce the segmental motion of the soft segments to decrease T_{g}. As extender, the higher Br-CNF contents and the availability of mom unreacted OHs on Br-CNF surface would hydrogen bonded with PTMEG (—OR), suppressing PTMEG phase separation into smaller soft domains thus lowered T_{g}. Melting temperature Tₘ (° C.) decreased from 18.9° C. to 12.0° C. with increasing Br-CNF contents from 0 to 0.3 w % as polyol, while decreased slightly to 16.2° C. with Br-CNF as extender up to 5.4 w %. In either polyol or extender role, increasing Br-CNF contents is expected to increase the extent of covalent bonding to MDI, lowering the extent of MDI-1.4-BD-MDI hard domains to lower Tₘ. The stronger covalent bonding between Br-CNF and MDI may be the reason for higher Tₘ reduction with Br-CNF as polyol than extender. One possible explanation for elevated Tₘ (14.6° C.) with increased Br-CNF as polyol from 0.3 to 0.5 w % may be that Br-CNFs extensively covalent bonded with MDI behave as crosslinkers and new hard domains to suppress mobility of the original MDI-1,4-BD-MDI hard domains.

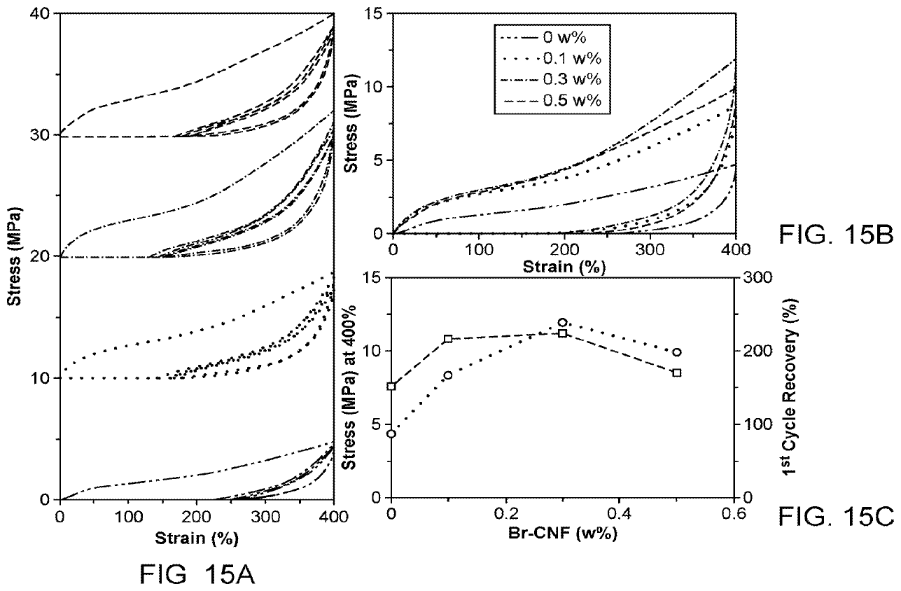

Cyclic tensile properties of polyurethane film with Br-CNF as polyol. To further investigate elastic and inelastic behaviors, uniaxial cyclic tensile strain/stress curves for PU/CNF films with 0, 0.1, 0.3 and 0.5 w % Br-CNF (0, 0.6, 1.8 and 3.1 mol % PTMEG OHS) as polyol was evaluated at up to 400% strain (FIG. 15A). The 1^{st} cycle tensile stress significantly increased from 4.4 to 11.9 MPa with increasing Br-CNF contents to 0.3 w %, then lowered to 9.9 MPa at 0.5 w %. In the 1^{st} cycle, the strain recovery for PU was 152% and increased to 223% with 0.3 w % Br-CNF polyol (FIGS. 15B and 15C). The behavior of decreasing stress at 400% with increasing number of cycles, or stress relaxation phenomenon, was observed for all three PU/CNF composites. At the end of 5^{th} cycle, stress at 400% strain decreased from 8.3 to 7.0 MPa, 11.9 to 9.5 MPa and 9.9 to 8.5 MPa, corresponding to 0.1, 0.3 and 0.5 w % Br-CNF contents, respectively, in contrast to the lacking stress relaxation for PU control. Those observed stress relaxation phenomenon possibly caused by realignment of Br-CNF along loading direction indicated the existence of irreversibility with Br-CNF as polyol at high strain to 400%. Nevertheless, the stress after five cycles of PU with Br-CNF polyols were significantly higher than PU. Both highest 11.9 MPa tensile stress and 223% 1^{st} cycle recovery observed at 0.3 w % Br-CNF as polyol confirmed this to be optimal PU/CNF composition to generate the most resilient film.

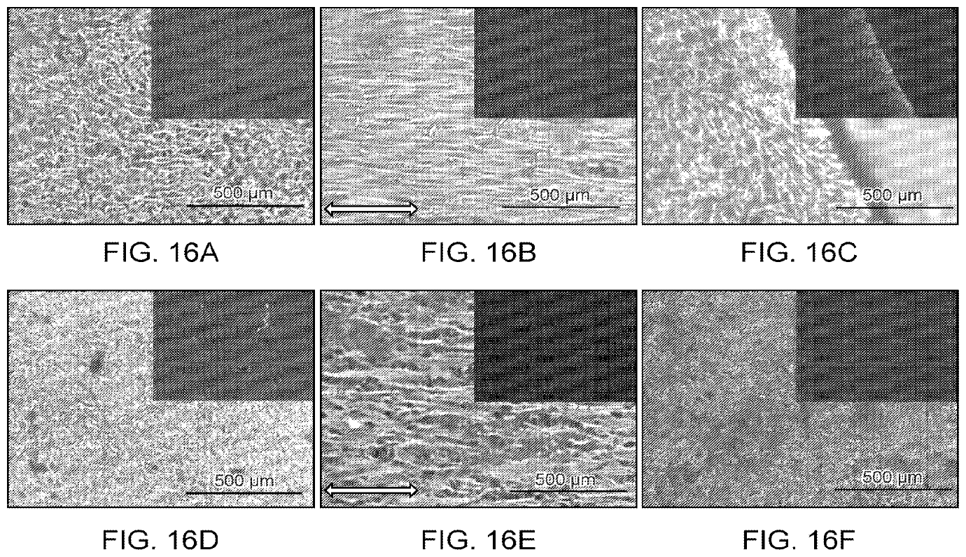

3.6 Orientation of Br-CNF in PU along loading direction. Films with 0.5 w % Br-CNF as polyol and 1.8 w % Br-CNF as extender were uniaxially stretched at up to 300% strain to observe their morphology by optical microscopy (FIGS. 16A-16F). The phase separated hard (MDI-1,4-BD-MDI) and soft (PTMEG) microdomains appeared as granular black and white clusters in the PU control whereas PU containing either 0.5 w % Br-CNF as polyol or 1.8 w % Br-CNF as chain extender displayed isotropically arranged microfibers, under both transmission and cross-polar modes (FIGS. 16A and 16D). The same microfibers were also observed with 0.1 and 0.3 w % Br-CNF as polyol. The presence of microfibers illustrated inter-fibril Br-CNF association possibly by hydrogen bonding. Upon uniaxial stretching, the microfibers appeared to align along the loading direction from strain-induced stress stiffening above 200%. All microfibers were reoriented along the loading direction at 300% strain (FIGS. 16B and 16E) and returned to original isotropic arrangement (FIGS. 16A and 16D) upon unloading. The observed foil reversibility for Br-CNF microfibers from isotropic (FIGS. 16A and 16D) to oriented alignment (FIGS. 16B and 16C) upon uniaxial stretching then back to isotropic (FIGS. 16A and 16D) upon returning to zero strain demonstrated apparent elastic behavior at up to 300% strain, unlike the inelastic stress relaxation observed at 400% strain (FIGS. 15A-15C). The film fractured at 539% strain also showed isotropic fibrils at fracture edge (FIG. 16C), indicative of fully reversibility of PU/CNF film after releasing loading force even in fracture region. The strain induced fiber realignment in PU with Br-CNF as extender (FIG. 16F) was not as clear as that with Br-CNF as polyol, supportive of the polyol role to be more effective in reinforcing PU.

### Conclusion

The stoichiometrically rationalized strategies demonstrated here show for the first time that 2-bromopropionyl bromide esterified cellulose nanofibrils (Br-CNF) facilely synthesized from one-pot esterification of cellulose with 2-bromopropionyl bromide (BPB) and in situ ultrasonication can serve the dual role to partially replace either chain extender or polyol in the syntheses of polyurethanes. The substituted surface 2-bromopropionyl ester (3.2 mmol/g) endows Br-CNF excellent DMF dispersibility while the unsubstituted surface OHs (3.5 mmol/g) are highly reactive to methylene diphenyl diisocyanate (MDI). Most importantly, the uniquely anisotropic (4.6 nm thick, 29.3 nm wide, ca. 1 μm long) and dual surface functional Br-CNF significantly reduced the MDI content to 15.7% with the use of longer polytetramethylene ether glycol (PTMEG, Mₙ:2,900 Da) as the soft segment. As polyol, replacing a merely 1.8 mol % of PTMEG OHs with the surface OHs of Br-CNF (0.3 w %) significantly improved the respective elastic modulus, tensile strength, and strain by 3.2, 3.9 and 1.5 times to 8.3 MPa, 21.1 MPa, and 755%. As chain extender, replacing 11 mol % of 1,4-butanediol OHs with the surface OHs of Br-CNF (1.8 w %) also improved the respective tensile properties to 8.3 MPa, 26.7 MPa, and 883%, in fact 27% higher in strength and 17% higher in modulus. However, 6 times of Br-CNF were required in the role as chain extender than that of polyol prepolymer. In the role of polyol prepolymer, the 0.3 w % Br-CNF of the PU synthesized is the lowest among reported to date while requiring only half of MDI. The experimental modulus exceeding those predicted by the Halpin-Tsai model gave evidence to the synergistic effectiveness of optimal covalent bonding of Br-CNF with MDI and hydrogen bonding between Br-CNF and PTMEG. Intriguingly, complete reversibility of isotropic Br-CNF under zero strain to oriented microfibril alignment at 300% strain extends the elastic recovery of PU to beyond the typical yield point. The efficiently synthesized Br-CNF with the unique organic compatibility and reactivity endowed by the respective surface 2-bromopropionyl ester and hydroxyls have enabled rationally designed and stoichiometric synthetic strategy for the synthesis of significantly stronger polyurethanes with 50% less diisocyanate. The newly synthesized 2-bromopropionyl esterified Br-CNFs offer novel synthetic strategies to not only maximize their reinforcing effect on polyurethane synthesized but also demonstrate potential the dual reactant and crosslinking roles of this functionalized nanocellulose in potential syntheses of other polymers.

### Example 6—Surface-Initiated Atom Transfer Radical Polymerization of Poly(Lauryl Methacrylate) on 2-Bromopropionyl Esterified Cellulose Nanofibrils as Rheology Modifier in Organic Media

We have successfully synthesized 2-bromopropionyl esterified CNF (Br-CNF) (T=4.7 nm, W=29.3 nm width, L=ca. 1 μm) via facile one-pot esterification of cellulose with 2-bromopropionyl bromide (BPB) followed by in-situ ultrasonication. This robust esterification-ultrasonication approach is tunable to convert varying extent of cellulose hydroxyls to organically compatible Br-esters to be applied as hydrophobic thin films or gels for blade coatings while the remaining surface hydroxyls could serve as reactive polyols for prepolymer synthesis or chain extension in synthesizing thermoplastic polyurethanes with significantly improved modulus (3.2×) and strength (3.9×) and strain-to-failure (1.5×). Uniquely, surface alkyl bromines on these novel Br-CNFs endow them the potential to serve as macroinitiators for self surface initiated ATRP (SI-ATRP) directly on CNF, presenting a significantly streamlined approach to the previously reported work involving multi-step processes of nanocellulose fabrication, freeze-drying and/or organic solvent exchange, and surface initiator immobilization via reaction of already prepared nanocelluloses. Furthermore, the optimally synthesized Br-CNF contains 3.2 mmol Br initiating group per g cellulose that is significantly higher than the 1.4-9.5 wt % or 0.44-1.19 mmol Br/g cellulose reported.

This study was to explore Br-CNFs as macroinitiators for direct grafting on Br-CNFs via Sl-ATRP of vinyl monomer lauryl methacrylate (LMA) to produce defined lengths of poly(lauryl methacrylate) (PLMA) bottle brush-like grafts or Br-CNF-g-PLMA for potential synergistic coupling of the properties of the Br-CNF core and PLMA surface graft. PLMA homopolymer has shown to be an excellent oil-soluble drag reducer, by reducing 68% drag with only 0.06 w % added in kerosene. Aqueous CNFs, being mechanical treated, TEMPO or periodate oxidized, have exhibited shear thinning rheological behaviors in coating, thickening, and 3D printing/bioprinting. By coupling the shear-thinning behavior of the CNF core and the drag reducing characteristics of the PLAM graft, these bottle brush-like Br-CNF-g-PLMA may present both characters synergistically to become novel drag reducers with shear-thinning behaviors in organic media.

SI-ATRP of LMA directly on Br-CNF was investigated using copper bromide (CuBr) catalyst and N,N,N′,N′,N′-pentamethyldiethylenetriamine (PMDBTA) ligand (Scheme 2). PMDETA was selected to yield the more stable copper(1) to mediate ATRP as compared to aliphatic amine ligand like 2,2′-bipyridine. Conversion of LMA into PLMA were studied by sequentially varying Br-CNF macroinitiator concentration [1](9.6 or 16 mM) and LMA monomer concentration [M](800 or 1600 mM) at varying reaction times (1-24 h).

The morphology of Br-CNF-g-PLMA was imaged by atom force microscopy (AFM) and their structures were characterized by attenuated total reflection (ATR) and solution phase proton nuclear magnetic resonance (¹H NMR) spectroscopy. Thermal properties were characterized by thermogravimetric analysis (TGA). Surface hydrophobicity of Br-CNF-g-PLMA copolymer were characterized by WCA measurements of their cast films. Br-CNF-g-PLMA with varied DPs were further investigated as rheology modifier in toluene or drag reducer in pump oil under varied shear rates and temperatures.

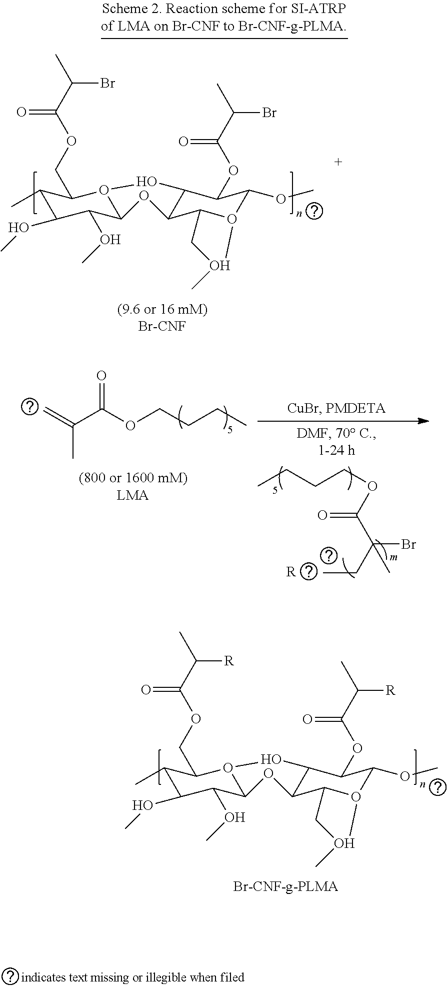

### Experimental

Materials. Cellulose was isolated from rice straw (Calrose variety) by a previously reported three-step 2:1 v/v toluene/ethanol extraction, acidified NaClO2 (1.4%, pH 3-4, 70° C., 5 h) delignification, and alkaline hemicellulose dissolution(5% KOH, 90° C., 2 h) process then lyophilized (Labconco Lyophilizer). Br-CNF was prepared by reported combined esterification (BPB:AGU-5:1, 6 h, 23° C.) and ultrasonication (Qsonica Q700, 50/60 Hz; 50% amplitude, 30 min) to 5.7 mmol surface Br esters estimated per g of cellulose, or equivalent to 3.2 mmol/g Br-CNF based on 80 wt % mass gain. Cuprous bromide (CuBr, Spectrum Chemical), N,N,N,N′,N′-pantamethyldiethylenetriamine (PMDETA, 99%, TC America), N,N-dimethylformamide (DMF, certified grade, Fisher Scientific), toluene (ACS grade, Spectrum Chemical), methanol (ACS grade, Sigma Aldrich), tetrahydrofuran (THF, ACS grade, Alfa Aesar), deuterated dimethyl sulfoxide-d& (DMSO-d₆, ≥99.5% isotopic, Thermo Scientific), acetone (certified grade, Fisher Scientific), silicone (high temperature, Thermo Scientific), and vacuum pump oil (Welch® DuoSeal®) were used as received without further purification. Lauryl methacrylate (LMA, 97%, TCI America) was flushed by 5 M sodium hydroxide solution to remove inhibitor then dried by molecule sieves overnight. Highly oriented pyrolytic graphite (HOPG, grade ZYB) was used for AFM characterization. For UV-vis spectrophotometry, UV-vis standard cell quartz cuvettes (Fisher Scientific, 10 mm path length) were used.

Br-CNF S1-ATRP with LMA, The Br-CNF macroinitiator at a 9.6 mM initiator concentration [1] was prepared by transferring 25 mL 0.3 w/v % Br-CNF (3.2 mmol/g) in DMF to a Schlenk flask to which catalyst CuBr (0.034 g, 0.24 mmol) was dissolved under constant stirring. The mixture was degassed by 5 min sonication (Branson 2510) and purged with nitrogen for 10 min then capped with a rubber septum. The PMDETA (50.1 μL, 0.24 mmol) complexing ligand was dissolved in LMA (5.1 g, 20.0 mmol) monomer and sonicated (1 min). The prepared LMA at [M]ₒ=800 mM was then injected through a syringe into flask to initiate polymerization at 70° C. silicone oil bath for 1, 3, 4.5, 6 or 24 h and terminated by adding 5 mL THE. Each final mixture was washed by cold methanol and centrifugated (Eppendorf 5804R, 5 k rpm, 10 min) to decant supernatant, then repeated two mom times to remove all catalyst and unreacted monomer. The final precipitate was vacuum dried (0.5 atm) at 50° C. overnight to obtain Br-CNF-g-PLMA in the form of an elastic gel. S1-ATRP of LMA was also performed at higher Br-CNF macroinitiator [1] and LMA [M]ₒ at 16 mM (25 mL 0.5 w/v % Br-CNF, 0.4 mmol Br) and 1600 mM (40.0 mmol), respectively, with at equal OA mmol of both CuBr and PMDETA for up to 24 h.

The conversion (%) of LMA to PLMA was determined by PLMA mass gain on Br-CNF-g-PLMA over initial LMA mass. According ATRP unity polydispersity or equal chain lengths of PLMA, the degree of polymerization (DPₘₐₛₛ) of PLMA based on mass gain was calculated as

$${DP}_{mass} = \frac{{m}_{2} - {m}_{1}}{0.2544 \times σ {m}_{1}} \qquad ( 1 )$$

where m₁ is Br-CNF mass (g), m₂ is Br-CNF-g-PLMA mass (g), 0.2544 (g/mmol) is the molecular mass of LMA, and a is the quantity of Br-CNF macroinitiator or 3.2 mmol/g Br ester⁵². level of substitution (ρ=0.48), defined as portion of OHs converted to Br esters, was calculated via ¹H-NMR.

Characterization. Br-CNFs (10 μL, 0.0005 w/v %) in DMF and Br-CNF-g-PLMA (10 μL, 0.0005 w/v %) in toluene were deposited on highly oriented pyrophoric graphite (HOPG), air-dried in fume hood for 6 h, and profiled by AFM (Asylum-Research MFP-3D) in the tapping mode in 5 μm×5 m scan size and at rate of 512 Hz.

For solution-state ¹H NMR (Bruker AVIII 800 MHz ¹H NMR spectrometer), Br-CNF was solvent exchanged to acetone then to DMSO-4 followed by vacuum evaporation (0.5 atm, 50° C., 1 h) as reported. Br-CNF-g-PLMA (ca. 10 mg) was added into 1 mL DMSO-da, sonicated (1 h), and centrifuged (5 k rpm, 10 min) to collect the supernatant for ¹H NMR. The substitution (φ of Br-CNF surface OHs to 2-bromopropionyl groups was quantified by solution state ¹H NMR for calculation of percent OH converted to Br initiating sites.

Br-CNF-g-PLMA elastic gel was oven-dried (56° C., overnight) for attenuated total reflectance (ATR) Fourier transform infrared (FTIR) spectroscopy and thermogravimetric analysis (TGA) characterization. For ATR characterization, each Br-CNF-g-PLMA was scanned by Thermo Nicolet 6700 FTIR spectrometer under ambient conditions from an accumulation of 128 scans at a 4 cm⁻¹ resolution from 4000 to 400 cm⁻¹. TGA was performed on each sample (10 mg) at 10° C./min from 25 to 500° C. under purging N₂ (50 mL/min) using a TGA-50 thermogravimetric analyzer (Shimadzu, Japan). Moisture content (%) was the mass loss at 140° C. and char residue (%) was the mass at 500° C.

Viscosities of Br-CNF in DMF at 0.5, 0.3 and 0.1 w/v % and Br-CNF-g-PLMA in toluene at 4, 6, 8 and 10 w/v % concentrations were measured at 25° C. with shear rates from 1 to 220 s⁻¹ using a Brookfield DV3T rheometer. Similarly, viscosities of Br-CNF-g-PLMA in toluene (4 w/v %) or oil (1, 2 and 4 w/v %) were measured at elevated temperatures of 40° C. and 55° C. Power law model was used to calculate the flow behavior index (n) of Br-CNF-g-PLMA in toluene as follows:

$$η = a {γ}^{n - 1} \qquad ( 2 )$$

where η is viscosity in mPa·s, a is flow consistency index, and γ is shear rate in s⁻¹.

Br-CNF-g-PLMA dispersions in toluene (1 w/v %) were scanned by UN-vis spectroscopy (Thermo Scientific, Evolution 600) from 325 to 800 cm⁻¹ at 4 cm⁻¹/s. Thin films were prepared by depositing ca. 1 mL Br-CNF-g-PLMA in toluene (1 w/v %) on clean glass slides and dried overnight in fume hood. Water contact angle (WCA) measurements on both sides of sessile drops Milli-Q water (5 μL) on Br-CNF-g-PLMA films were measured on a total of 5 images (n=5). using the ImageJ Analyzer and the average values reported.

Rheology of Br-CNF-g-PLMA Dispersions in Toluene and Pump Oil. Br-CNF-g-PLMA (1.5 g) with DPₘₐₛₛ=16, 32, 40 and 46 was added in 10 mL toluene then sonicated (Branson 2510) 1 h to prepare homogeneous dispersions at 15 w/v % for viscosity measurements at varied shear rates from 1 to 220 s⁻¹ shear rates at 25° C. The same procedure was repeated for 10, 8, 7, 6, 4, 2, 1 and 0.5 w/v % Br-CNF-g-PLMA in toluene. For Br-CNF-g-PLMA with DPₘₐₛₛ=3, 0.2 g was added in 5 mL toluene then sonicated 1 h to prepare 4 w/v % homogeneous dispersion and 2, 1 and 0.5 w/v % serial dilutions for the same rheology measurements. To prepare pump oil dispersions, 10 mL vacuum pump oil was added to 4 w/v % Br-CNF-g-PLMA toluene dispersion, sonicated for 10 min, then was vacuum oven dried (0.5 atm, 30° C., 24 h) to evaporate toluene to 4 w/v % Br-CNF-g-PIMA oil dispersion. This 4 w/v % was then serial diluted to 2 and 1 w/v % Br-CNF-g-PLMA oil dispersions.

### Results and Discussion

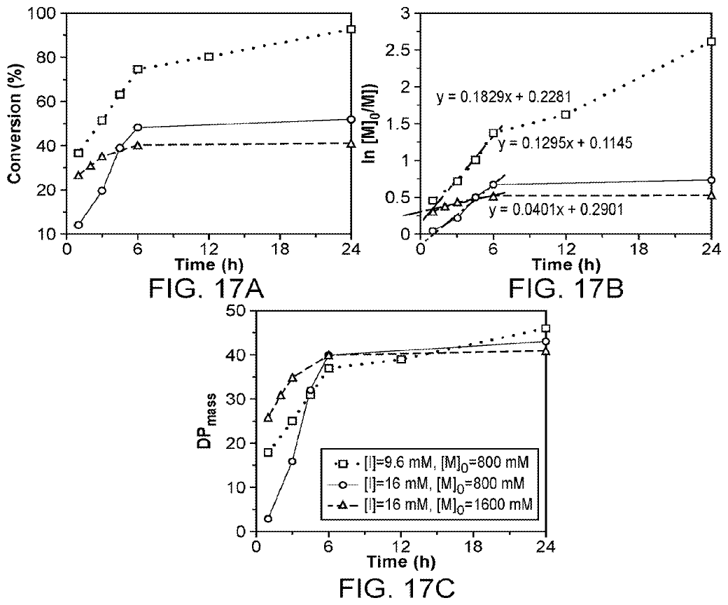

SI-ATRP on Br-CNF. Sl-ATRP of LMA on Br-CNF was conducted at 70° C. with 9.6 or 16 mM Br-CNF macroinitiator concentration [I], 800 or 1600 mM LMA monomer concentration [M]ₒ for 1 to 24 h (Table SI). The overall LMA to PMLA conversion and semilogarithmic in [M]ₒ/[M] monomer consumption increased with polymerization reaction time at up to 6 h, then leveled (FIGS. 17A and 17B). The exception was the continuing increase of LMA consumption at 16 mM [I] and 800 mM [M]. At the lower 800 mM [M]ₒ, higher apparent LMA consumption at a rate constant of 0.1829 h⁻¹ was observed at higher [I], 41% higher than the 0.1295 h⁻¹ rate constant for the lower [I], as expected. However, at the higher 16 mM [I], the apparent rate constant with the higher 1600 mM [M]., or 100 [M]ₒ/[I] ratio, was 0.0401 h⁻¹, only about one fifth of that at 800 mM, half of [M]ₒ. The lower rate constant at high [M]ₒ might be attributed to pre-termination at early stage (t<1 h). At 9.6 mM [I] and 800 mM [M], or 83 [M]ₒ/[I] ratio, LMA to PLMA conversion raised most rapidly with polymerization time to 74.8% at 6 h, then further increased to reach 92.7% at 24 h. Clearly, higher conversion was achieved at the highest macroinitiator [I] of 16 mM, but optimized at 83 [M]ₒ to [I] ratio.

Under the equal chain length assumption for ATRP, DPₘₐₛₛ for PLMA grafts on Br-CNF surfaces by eqn (1) increased dramatically from 3, 18, and 26 to the similar 37 to 40 range with increasing polymerization time from 1 to 6 h (FIG. 17C), then only slightly increased to the 41 to 46 range at 24 h. The negligible chain growth beyond 40 DPₘₐₛₛ suggest chain termination beyond 6 h, possibly via chain transfer. Thus, 6 h is the optimal propagation time for preparing Br-CNF-g-PLMA with ca. 40 repeating units under all three scenarios. Taking highest monomer conversion, polymerization rate, and achievable graft chain length into consideration, 800 mM [M]ₒ, 16 mM [I], and 24 h were deemed the optimal condition to reach the 927% conversion, significantly higher than all previously reported conversions, i.e., 15 to 35% on as-is CNCs and 23 to 85% even with added sacrificial initiators. The robust polymerization and significantly higher monomer to PLMA conversion reflects the uniquely high Br ester contents and the excellent compatibility of Br-CNF in the reaction media. The superior accessibility of initiating cites on the Br-CNF macroinitiator surfaces further confirms the advantage of this one-pot synthesis via esterification of cellulose with 2-bromopropionyl bromide (BPB) and in-situ ultrasonication.

Mₙ of Br-CNF-g-PLMA by viscosity. Sl-ATRP was highly effective in polymerizing LMA on Br-CNF surfaces to produce Br-CNF-g-PLMA with substantial surface grafts that the Br-CNF core only amounted to 2.7 to 7.4 w % of Br-CNF-g-PLMA except for 28.1 w % from the lowest 4% conversion and 3 DPₘₐₛₛ (Table SI). The commonly used solution viscosity for molecular mass determination of homopolymers was applied to calculate Mn for grafted copolymer. The most grafted Br-CNF-g-PLMA with highest 46 DPₘₐₛₛ was suspended in pyridine, ethyl acetate, chloroform, toluene, and hexane at 5 w/v % to determine the most compatible solvent. Only the toluene dispersion was transparent while all other dispersions were translucent, indicative of toluene being the most compatible solvent to PLMA surface graft. The viscosities of five Br-CNF-g-PLMA with 3, 16, 32, and 40 (FIG. 17A) as well as that with 46 (FIG. 17B) DPₘₐₛₛ in toluene at varied concentrations were measured at 25° C. M of Br-CNF-g-PLMA was estimated by Mark-Houwink equation for homopolymer as

$${M}_{a} = {( [ η ] / K )}^{1 / α} \qquad ( 3 )$$

where K and α are Mark-Houwink parameters (0.73×10⁻² ml/g, 0.69) for PLMA in THF, in absence of reported values in toluene. [η] is the intrinsic viscosity from extrapolation of natural logarithm of relative viscosity (ln ηᵣ) or the specific viscosity (η_{SP}) over concentration (C) to the y axis. Since mom PLMA compatible toluene is less polar. K and α values from the more polar THF may be higher, leading to an underestimation of Mₙ. The plots of inherent viscosity

$$( \frac{\text{?}}{C} )$$

$$\text{?} \text{indicates text missing or illegible when filed}$$

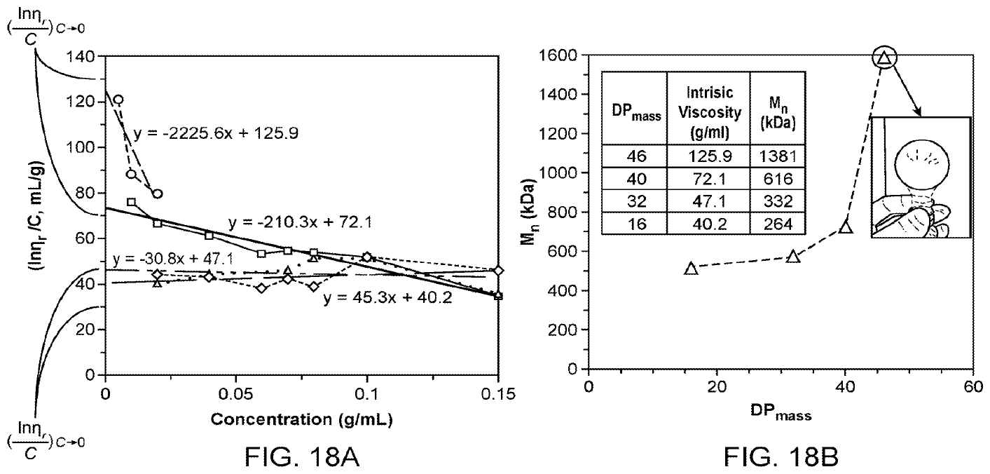

verse concentrations for Br-CNF-g-PLMA with corresponding estimated Mₙ were displayed (FIGS. 18A and 18B).

To meet sufficiently dilute concentrations criteria for accurate intrinsic viscosity determination, only inherent viscosities obtained from concentrations lower than 0.15 g/mL Br-CNF-g-PLMA in toluene were used. In addition, only the linear regions for each sample were included (FIG. 18A). Ma derived by inherent viscosity

$$( \frac{\text{?}}{C} )$$

$$\text{?} \text{indicates text missing or illegible when filed}$$

moderately increased from 264 to 616 kDa, corresponding to increasing DPₘₐₛₛ from 16 to 40, then mom than doubled to 1381 kDa (2.2×) or 46 DPₘₐₛₛ (FIG. 18B). Similarly, Mn derived by reduced viscosity

$$( \frac{{η}_{SP}}{C} )$$

moderately increased from 386 to 671 kDa with increasing DPₘₐₛₛ from 16 to 40, then more than doubled to 1592 kDa (2.4×) with slightly increased DPₘₐₛₛ from 40 to 46. The inherent viscosity

$$( \frac{\text{?}}{C} )$$

$$\text{?} \text{indicates text missing or illegible when filed}$$

was considered more reliable than reduced viscosity

$$( \frac{{η}_{SP}}{C} )$$

in deriving Mₙ due to their better linear relationships. With increasing grating lengths of hydrophobic LMA on relative hydrophilic Br-CNF surface, DMF dispersions of Br-CNF-g-PLMA was transparent initially, became milky at 1 h, then phase separated at 3 h, and finally reached gelation (800 mM [M]ₒ, 16 mM [I]) at 24 h. This observation indicated Br-CNF-g-PLMA with longer PLMA chain lengths became less compatible to the polar DMF to coalesce and the surface grafted chains contracted around the Br-CNF core. Since viscosities were only obtained from concentrations before reaching gelation (FIG. 18A), one possible reason for significantly increase on Mₙ along with slight increase in DPₘₐₛₛ from 40 to 46 (FIG. 18B) was attributed to chain transfer in which one radical chain terminus reacts to a dead PLMA chain of another to significantly lengthen the graft while creating a new radical on the other. Br-CNF core and PLMA surface grafts in varying lengths, i.e., 3-46 DPₘₐₛₛ or 264-1381 kDa Mₙ, have been robustly synthesized directly on Br-CNF using it as macroinitiator at high conversion up to 92.7% (Table S2).

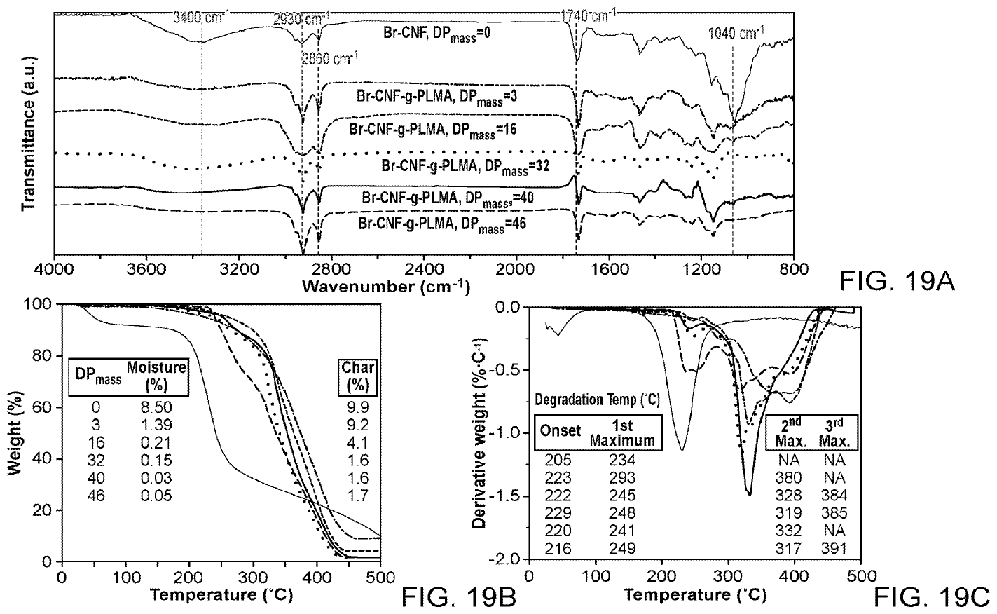

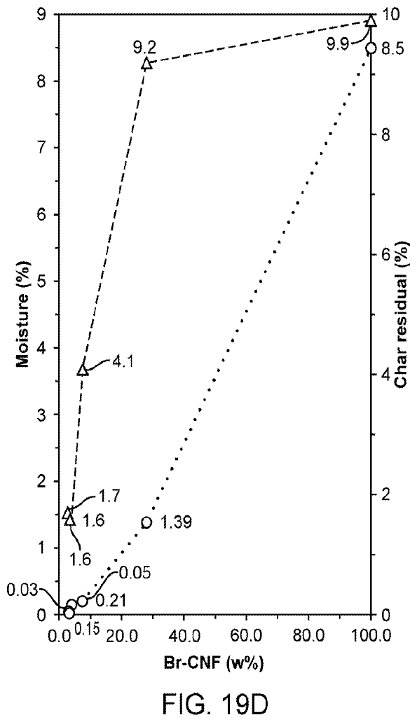

Characterization of Br-CNF-g-PLMA by ATR spectroscopy and thermal analysis. The FTIR of Br-CNF showed prominent 3400 cm⁻¹ O—H and 1040 cm⁻¹ C—O and C—C—O (1035 cm⁻¹) stretching peaks, characteristics cellulose, whereas the appearance of ester C-O stretching peak at 1740 cm⁻¹ confirmed the successful conversion of cellulose OHs to 2-bronopropionyl esters (FIG. 19A). This 1040 cm⁻¹ peak intensity dramatically reduced for Br-CNF-g-PLMA with 3 and 16 DPₘₐₛₛ, then disappeared for those with higher DPₘₐₛₛ of 32, 40 and 46, constant with their very low respective 3.8, 3.1 and 2.7 w % cellulose contents, whereas the O-H stretching peak at 3400 cm⁻¹ disappeared for all Br-CNF-g-PLMA irrespective of their DPs, corresponding to absence of moisture. The ester C═O stretching at 1740 cm⁻¹ from esters on Br-CNF and PLMA grafts remain similar while both ester sp³ and sp² C—C stretching peaks at 2860 cm⁻¹ and 2930 cm⁻¹ were slightly more intense for Br-CNF-g-PLMA. With increasing PLMA graft lengths from 0 to 46 repeating units, the corresponding Br-CNF contents decreased significantly from 100 to 3.1 w %, the moisture contents proportionally reduced from 8.30% to 0.05%, char residue (%) lowered from 9.9 to 1.7%, and the onset and maximum decomposition temperatures elevated by 11 to 24° C. and 7 to 59° C., respectively (FIGS. 19B-19D). All Br-CNF-g-PLMAs showed 2^{nd}, even 3^{rd} max degradation at and above 317° C., where the second is close to reported 327° C. depolymerization temperature for of PLMA (Mₙ=29 kDa).

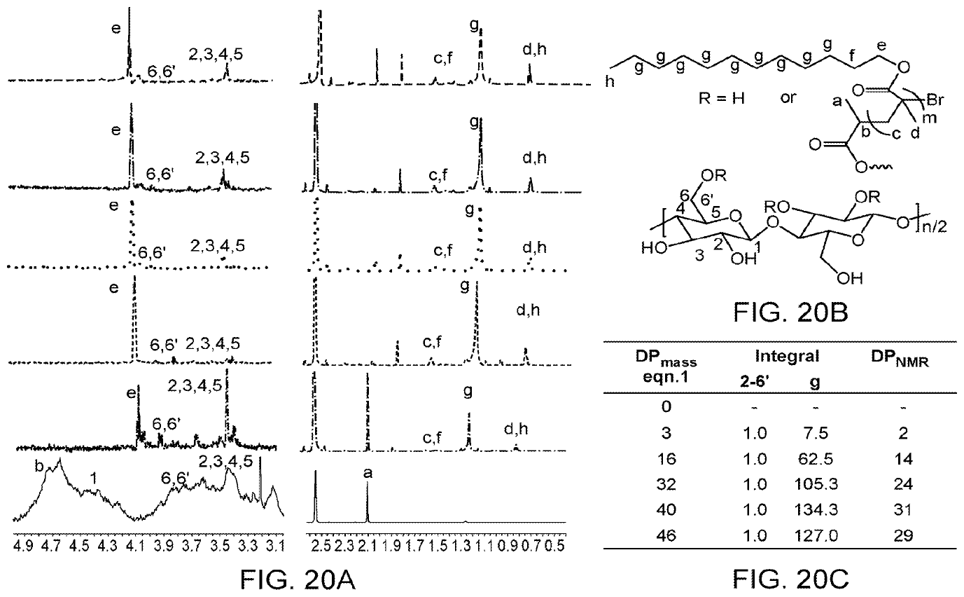

Degree of polymerization (DP) of PLMA graft by solution-state ¹H-NMR. The ¹H-NMR spectra of Br-CNF and Br-CNF-g-PLMA with varied DPs (FIG. 20A) were displayed with corresponding protons (FIG. 20B). The ¹H-NMR spectra of all five Br-CNF-g-PLMA spectra showed the furthest downfield H6 and H6′ peaks of the Br-CNF protons at δ 3.63-3.89, consistent with those at δ 3.71-4.06 for Br-CNF and δ 3.65-3.88 for dissolved MCC in NaOD/D₂O. Multiple overlapping peaks between δ 3.29-3.58 were assigned to H2, H3, H4 and H5, matching those at δ 3.16-3.70 of Br-CNF and δ 3.27-3.66 of TEMPO-CNF in D₂O. The theoretical furthest downfield cellulosic H1 proton peak at δ 4.20-4.52 in Br-CNF disappeared upon grafting with PLMA due to potential overlapping with broad PLMA methylene H at δ 4.10. For proton peaks on grafted PLMA chains, chemical shift of H., Hₑ+H_{f}, H_{d}+Hₕ, and H_{g} were assigned to δ 4.05, δ 1.41-1.58, δ 0.81, and δ 1.13-1.27, corresponding to δ 3.96, δ 1.65-1.84, δ 0.93 and δ 1.32 of homopolymer PLMA in chloroform-di. The average ratios of integrated protons H. (methylene, —CH₂—O—): Hₑ+H_{f} (methylene, —CH₂—):H_{d}+Hₕ (methyl, —CH₃—):H_{g} (methylene, —(CH₂)₉— peaks were 1:1.9:2.3:12.8 for all five Br-CNF-g-PLMAs, close to the theoretical 1:2:3:9 proton ratio to confirm these proton assignment for the PLMA grafts.

Assuming all anomeric protons of amorphous and surface AGUs of Br-CNF are detectable by ¹H NMR, surface AGUs was the sum of the integrated areas for anomeric H2 to H6′ proton peaks, averaged by 6 anomic protons for amorphous or 3 anomic protons from the half exposed on the surface. H1 proton peak was excluded due to overlapping with methylene proton (Hb). LMA units could be estimated by integration of the areas of methylene He divided by 18 respective protons. LMA units per surface AGU was determined mathematically by the area ratio of LMA calculated from H_{g} over surface AGUs calculated from H2 to H6′. The DP_{NMR} could be calculated from DPs in the amorphous region or crystalline surfaces as follows.

For amorphous Br-CNF, each AGU has 3 exposed OHs, D_{NMR,amorphous} representing the # of LMA per initiating sites, was calculated by dividing # of LMA by 3 OHs per AGU and level of substitution (ρ=0.48) as

$${DP}_{NMR , amorphous} = \frac{1}{3 \times ρ} \times \frac{intergal of methylene protons ( {H}_{g} ) / 18}{{\sum }_{2}^{\text{?}} intergal of anomeric protons ( {H}^{i} ) / 8} \qquad ( 4 )$$

$$\text{?} \text{indicates text missing or illegible when filed}$$

For crystalline surfaces of Br-CNF, each cellobiose (two AGUs) has three exposed OHs, DP_{NMR,crystalline}, representing the # of LMA per initiating sites, was calculated by dividing # of LMA by 1.5 OHs per surface AGU and level of substitution (ρ=0.48) according to eqn. (5)

$${DP}_{NMR , crystalline} = \frac{1}{1.5 \times ρ} \times \frac{intergal of methylene protons ( {H}_{g} ) / 18}{2 \times {\sum }_{2}^{\text{?}} intergal of anomeric protons ( {H}^{i} ) / 6} \qquad ( 5 )$$

$$\text{?} \text{indicates text missing or illegible when filed}$$

Since DP derived from either amorphous regions or crystalline surfaces gave the same from by eqn (4) or (5), DP_{NMR}=DP_{NMR,amorphous}=DP_{NMR,crystalline}. Where p is 0.48, or 48% OHs on surface AGUs of Br-CNF were converted to Br initiating sites. DP_{NMR} calculated by ¹H NMR were 2, 14, 24, 31, and 29 for Br-CNF-g-PLMA, lower than the DPₘₐₛₛ estimated from mass gain (eqn. 1) by 12.5% to up to 37% (FIG. 20C). In the polar DMSO-d₆ used for solution-state NMR, the mom hydrophilic Br-CNFs were dispersed but the increasingly more hydrophobic Br-CNF-g-PLMA with longer or higher DP hydrophobic PLMA became less dispersible to be fully detected by NMR thus underestimated H_{g} and DPₘₐₛₛ than the DP derived by mass balance. Never-the-less, this is the first successful demonstration of direct chain length determination (without chain cleavage) of grafted polymers on nanocellulose surfaces via ¹H NMR. This direct analytical approach is significant in particular for such opposing dispersibility of hydrophilic Br-CNF backbone and hydrophobic surface PLMA grafts.

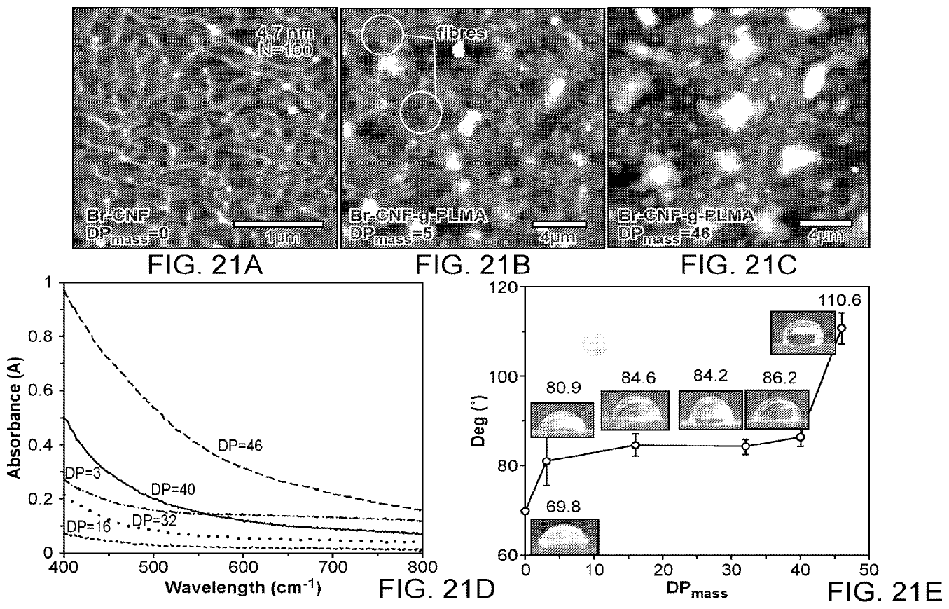

Surface Compatibility of Br-CNF-g-PLMA. Br-CNF and Br-CNF-g-PLMA (DPₘₐₛₛ=3 and 46) were imaged by AFM on freshly exfoliated graphite. Br-CNF spread evenly and appeared as interconnecting nanofibrils with 4.7 nm average thickness and varying lengths at the order of ca. 1 μm (FIG. 21A). Br-CNF-g-PLMA with 3 DPₘₐₛₛ grafts agglomerated into particulates with some nanofibrils (FIG. 21B) whereas Br-CNF-g-PLMA with the longest 46 DPₘₐₛₛ grafts appeared as larger particulates only (FIG. 21C). With increasing lengths of hydrophobic PLMA grafts, Br-CNF-g-PLMA became increasingly incompatible to the moderately hydrophobic graphite surface (WCA-71.8°) to coil and aggregate. All 1 w/v % Br-CNF-g-PLMA (DPₘₐₛₛ=3, 16, 32, 40 and 46) dispersions in toluene appeared transparent, but transmitted less visible light from 400 to 800 cm⁻¹ wavelength with increasing grafted DP from 16 to 46 (FIG. 21D). Br-CNF-g-PLMA with longer grafts led to higher molar attenuation coefficient in Beer-Lambert law, causing increased absorbance at same concentration and path length. The Br-CNF-g-PLMA with shortest 3 DPₘₐₛₛ graft was least compatible with the nonpolar toluene to aggregate, increasing molar attenuation coefficient to higher absorbance than those with 16 and 32 DPₘₐₛₛ. The WCAs of casted films increased from 69.8° for Br-CNF to 80.9° and 86.2° for Br-CNF-g-PLMA with respective 3 and 40 DPₘₐₛₛ, then significantly increased to 110.6° for Br-CNF-g-PLMA with 46 DPₘₐₛₛ, (FIG. 21E). The slightly increased surface hydrophobicity of Br-CNF-g-PLMA than Br-CNF reflect the slightly more hydrophobic PLMA than 2-bromopropionyl ester of Br-CNF, but the hydrophobicity was lees dependent on the PLMA chain lengths until reaching 46 DPₘₐₛₛ, the gelation point (FIG. 18B).

### Br-CNF-g-PLMA as Viscosity Modifier

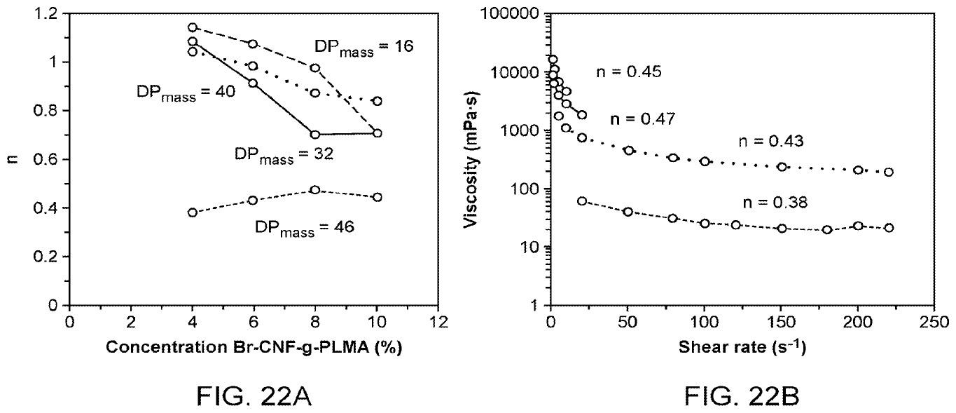

Viscosities of Br-CNF-g-PLMA at varied shear rate. The viscosities (η) of Br-CNF-g-PLMA of varied graft lengths and concentrations (4, 6, 8 and 10 w/v %) were measured at 1 to 220 s⁻¹ shear rates (γ) at 25° C. to derive the flow behavior index (η) from the slope (n−1) of natural logarithm η vs γ plot according to the Power law model η=aγⁿ⁻¹ (egn 2), Theoretically, n<1 indicates pseudoplastic or shear-thinning behavior of a liquid. For Br-CNF-PLMA with short 16 DPₘₐₛₛ grafts, Newtonian behaviors were observed at lower concentrations and shear thinning behavior was apparent only at 10 w/v % (n=0.72) (FIG. 22A). As PLMA grafts lengthened to 32 and 40 DPₘₐₛₛ, shear-thinning behaviors were observed at 10 and 8 w/v % with corresponding n values near 0.71 and 0.84-0.87, respectively. Only Br-CNF-g-PLMA with longest 46 DPₘₐₛₛ grafts exhibited pseudoplastic behaviors at all concentrations from 4 to 10 w/v % with lower n values between 0.38 and 0.47 (FIG. 22B). The Newtonian behavior Br-CNF-g-PLMA at lower concentrations are in similar trend as Br-CNF in DMF². Br-CNF dispersions in DMF exhibited Newtonian behaviors, i.e., their viscosities were independent of shear rates from 0.06 to 0.25 w/v %, but exhibited a shear thinning region at low shear rates below 150 s⁻¹ and a Newtonian region above at 0.5 w/v %. The shear-rate dependent viscosity thresholds of Br-CNF-g-PLMA concentrations in toluene are, however, ca. one magnitude higher, attributing to the much greater effects of PLMA grafts. Shear thinning phenomenon of Br-CNF and viscosity enhanced effects of PLMA were successfully combined via ATRP for production of Br-CNF-g-PLMA.

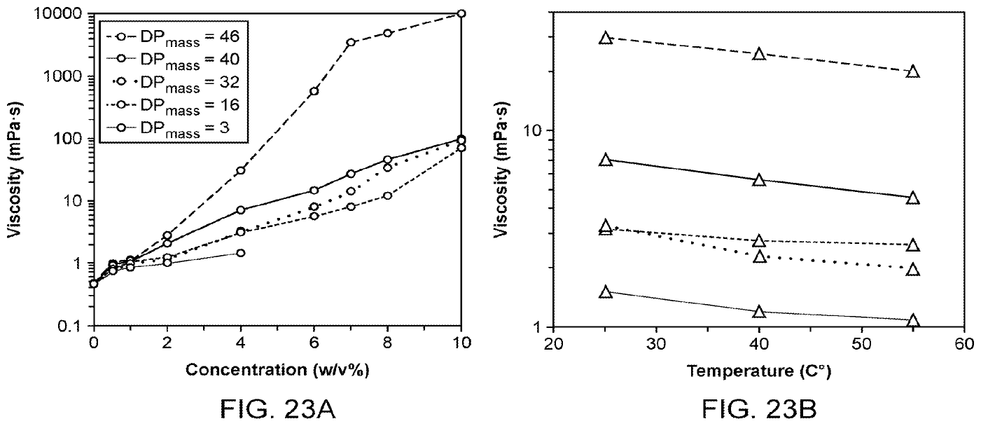

Br-CNF-g-PLMA rheology at expanded concentrations and elevated temperatures. Rheology of Br-CNF-g-PLMA in toluene were evaluated to include lower concentrations (0.5 to 10 w/v %) and elevated temperatures (25, 40 and 55° C.)(FIGS. 23A and 23B). Viscosities of Br-CNF-g-PLMA in toluene at the lowest 0.5 w/v % concentration were all below 1 mPa·s, only slightly higher than the 0.464 mPa·s of toluene alone (FIG. 23A). Viscosities of Br-CNF-g-PLMA with shorter chain lengths (DPₘₐₛₛ=3, 16 and 32) moderately increased to 1.51 (3.3×), 3.16 (6.8×) and 3.24 (7.0×) mPa·s as concentration increased to 4 w/v %, while viscosities of those with longer chains (DPₘₐₛₛ=40 and 46) significantly increased to 6.93 (15×) and 29.7 (64×) mPa·s at 4 w/v % concentrations. As concentration increased to 10 w/v %, viscosities of Br-CNF-g-PLMA (DPₘₐₛₛ=16, 32 and 40) significantly increased (153 to 211×), while that with longest side chain (DPₘₐₛₛ=46) appeared as a viscous gel with dramatically increased 9,777 mPa·s viscosity (21,071×). At constant 4 w/v %, the viscosities of all Br-CNF-g-PLMA with varied DPₘₐₛₛ decreased with increasing temperatures from 25 to 55° C. (FIG. 23B), as expected. The viscosities reduced slightly more to 0.61×, 0.64× and 0.67× for Br-CNF-g-PLMA with longer 32, 40 and 46 DPₘₐₛₛ grafts than to 0.71× and 0.84× for those with shorter 3 and 16 DPₘₐₛₛ grafts, respectively. The enhanced viscosity improvement with longer side chain was also observed, in which viscosity significantly increase to 9.3× or 307× with increase of DPₘₐₛₛ from 16 to 46 at respective 4 or 8 w/v %. The longer PLMA grants on Br-CNF surface are expected to increase inter Br-CNF-g-PLMA attractions at any given concentration to resist flow, causing more significant viscosity enhancement than those with shorter grafts, for application as viscosity modifiers in paints and coatings.

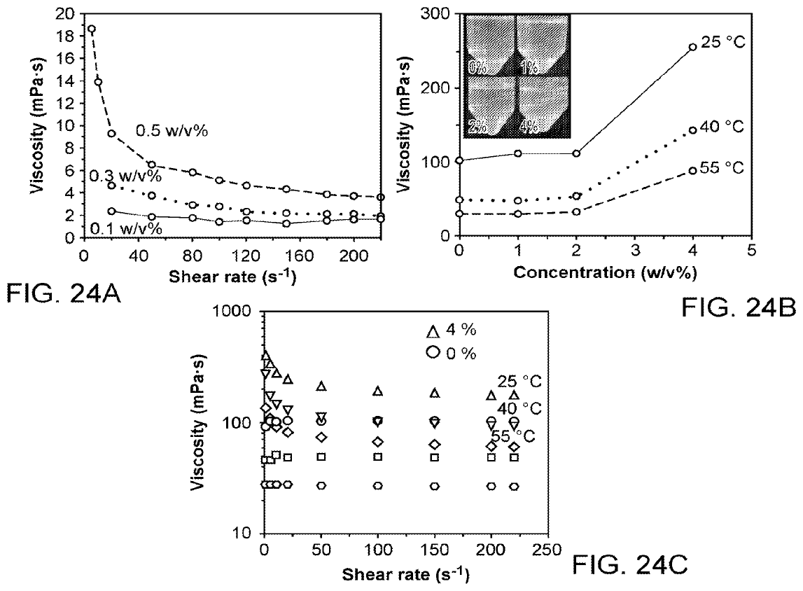

Br-CNF-g-PLMA as drag reducer in pump oil. Br-CNF-g-PLMA with the longest 46 DPₘₐₛₛ PLMA graft exhibited the most (least n values) and consistent shear-thinning behaviors at 4 to 10 w/v % and was used to evaluate their drag reducing effects in oil-based fluid. Br-CNF-g-PLMA was solvent exchanged from toluene to pump oil at 0.1, 0.3, and 0.5 w/v % to measure their viscosities over varied shear rates (FIG. 24A). Viscosity decreased to %, % and Vs for respective 0.1, 0.3, and 0.5w/v % Br-CNF-g-PLMA when shear rates increased from 1 to 220 s⁻¹, showing more significant shear-thinning behaviors with increasing concentrations. _{Incorporating more} Br-CNF-g-PLMA in pump oil at higher 1, 2 and 4 w/v % also appear translucent (FIG. 24B). At 25° C., viscosities slightly increased from 102.2 to 110.9 mPa-s at up to 2 w/v % Br-CNF-g-PLMA, then significantly increased to 256.0 mPa·s at 4 w/v %. Similar trends were also observed at elevated temperatures of 40 and 55° C., indicating 4 w/v % was the adequate concentration for Br-CNF-g-PLMA to function as a viscosity transducer. Pure pump oil exhibited Newtonian behavior at all three temperatures, while shear-thinning phenomenon occurred with the addition of 4 w/v % Br-CNF-g-PLMA (FIG. 24C). Viscosity at 25° C. significantly increased from 104.2 mPa·s to 406.3 mPa·s (3.9×) at 1 s⁻¹ and only slightly increased to 178.2 mPa·s (1.7×) at 220 s⁻¹. At elevated temperature of 55° C., viscosity dramatically increased to 5.0× and 2.2× at respective 1 and 220 s⁻¹. The more significant viscosity enhancing effect have validated the capability of Br-CNF-g-PLMA as a highly effective oil drag reducer at low temperatures. Furthermore, the addition of 4% Br-CNF-g-PLMA also converted the turbulent flow to laminar (low to save energy.

### CONCLUSION

This work has demonstrated that the one-pot synthesized Br-CNF could function as highly effective macroinitiators for surface-initiated atom transfer polymerization (S1-ATRP) of vinyl monomer lauryl methacrylate (LMA) in controlled gran lengths with excellent conversions up to 92.7%, significantly higher than all previous reported nanocelluloses prepared by multiple steps and many even aided by added sacrificial initiators. SI-ATRP of Br-CNF was robust, following first order kinetics, evident by linear semilogarithmic monomer consumption vs time plots, in high apparent rate constants of 0.1295 h⁻¹ and 0.1829 h⁻¹ at respective 9.7 mM and 16 mM Br-CNF macroinitiator [I] concentrations. The Br-CNF-g-PIMA synthesized contained significant surface PLMA grafts with only 2.7 to 74 w % Br-CNF core. The molecular mass of Br-CNF-g-PLMA derived by inherent viscosity (lmₓ/C) ranged from 264 to 1381 kDa whereas the surface PLMA grafts directly quantified by solution-state ¹H NMR in DMSO-d gave 2-31 DP_{NMR}, 12.5 to 37% underestimated than the 3-46 DPₘₐₛₛ derived by mass balance. These Br-CNF-g-PLMA with controlled graft lengths have proven to be highly effective viscosity modifiers in organic media since it combined shear thinning behavior of Br-CNF core and viscosity enhancing effect of PLMA grafts. Especially, Br-CNF-g-PLMA (DP=46, 4 w/v %) could be fully dispersed in silicon pump oil as drag reducer to enhance viscosity up to 5 times at 25 to 55° C. This study validated the role of Br-CNF as a novel macroinitiator for direct SI-ATRP of vinyl polymers as demonstrated by PLMA and demonstrated the surface grafted Br-CNF-g-PLMA couples synergistically the thinning behavior of Br-CNF core and viscosity modifying and drag reducing behaviors of surface PLMA grafts, expanding applications of Br-CNF beyond hydrophobic coating and polyol for polyurethane previously demonstrated.

### REFERENCES

1. L. Chen, J. Zhu, C. Baez, P. Kitin and T. Elder, Green Cham., 2016, 18, 3835-3843.
2. S. Iwamoto, W. Kai, A. Isogai and T. Iwata, Biomacromolecules, 2009, 10, 2571-2576.
3. H. Fukuzumi, T. Saito and A. Isogai, Carbohydr. Polym., 2013, 93, 172-177.
4. J. A. Diaz, X. Wu, A. Martini, J. P. Youngblood and R. J. Moon, Biomacromolecues, 2013, 14, 2900-2908.
5. B. Puangsin, Q. Yang, T. Saito and A. Isogai, Int J. Biol, Macromol., 2013, 59, 208-213.
6. Y.-S. Ye, HX. Zeg, J. Wu, L-Y. Dong, J.-T. Zhu, Z.-G, Xuc, X.-P. Zhou, X.-L Xie and Y.-W. Mai, Green Chem., 2016, 18, 1674-1683.
7. B. Thomas, M. C. Raj, J. Joy, A. Moores, 0. L. Drisko and C. Sanchez, Chemical reviews, 2018, 119, 11575-11625.
8. Y. Habibi, L. A. Lucia and O. J. Rojas, Chem. Rev., 2010, 110, 3479-3500.
9. D. Bondeson, A. Mathew and K. Okaman, Celluloe, 2006, 13, 171.
10. S. Elarzouzi-Hafraoui, Y. Nishiyama, J.-L-Putaux, L. Heux, F. Dubreuil and C. Rochas, Biomacromolecules, 2007, 9, 57-65.
11. A. Dufreane, Materials Today, 2013, 16, 220-227,
12. F. Jiang and Y.-L. Hsieh, Carbohydr. Polym., 2013, 95, 32-40.
13. T. Saito, Y. Nishiyama, J.-L. Putaux, M. Vignon and A. Isogai, Biomacromolecules, 2006, 7, 1687-1691.
14. A. Isogai, T. Saito and H. Fukuzumi, Nanoscale, 2011, 3, 71-85.
15. M. S. Wang, F. Jiang, Y.-L. Hsich and N. Nitin, J. Mater. Chem B, 2014, 2, 6226-6235.
16. F. Jiang and Y.-L. Isich, ACS Sustainable Chem. Eng., 2016, 4, 1041-1049.
17. F. Jiang, S. Han and Y.-L. Hsich, Rsc Adv., 2013, 3, 12366-12375,
18. T. Saito and A. Isogai, Biomacromolecules, 2004, 5, 1983-1989.
19. J. Li, X. Wei, Q. Wang, J. Chen, G. Chang, L. Kong, J. Su and Y. Liu, Carbohydr. Polym., 2012, 90, 1609-1613.
20. M. Pääkkö, M. Ankerfors, H. Kosonen, A. Nykänen, S. Ahola, M. Österberg, J. Ruokolainen, J. Laine, P. T. Lamson and O. Ikkala, Biomacromolecules, 2007, 8, 1934-1941.
21. L Wägberg, G. Decher, M. Norgren, T. Lindström, M. Ankerfors and K. Axnäs, Langmuir, 2008, 24, 784-795.
22. C. Aulin, E. Johansson, L. Wigberg and T. Lindström, Biomacromolecules, 2010, 11, 872-882.
23. A. Pei, J.-M. Malho, J. Ruokolainen, Q. Zhou and L. A. Berglund, Macromolecules, 2011, 44, 4422-4427.
24. M. L. Auad, V. S. Contos, S. Nutt, M. 1. Aranguren and N. E. Marcovich, Polym. Int., 2008, 37, 651659.
25. D. Viet, S. Beck-Candanedo and D. G. Gray, Cellulose, 2007, 14, 109-113.
26. S. Fujisawa., T. Ikeuchi, M. Takeuchi, T. Saito and A, Isogai, Biomacromolecules, 2012, 13, 2188-2194,
27. M. Fumagalli, F. Sanchez, S. Molina-Boissea and L. Heux, Cellulose, 2015, 22, 1451-1457.
28. A. Ashori, M. Babaee, M. Jonoobi and Y. Hamzeh, Carbohlydr. Polym., 2014, 102, 369-375.
29. A. Tripathi, M. Ago, S. A. Khan and O. J. Rojas, ACS Appl. Mater. Interfaces, 2018, 10, 44776-44786.
30. F. Valdebenito, R. Garcia, K. Cruces, G. Ciudad, G. Chinga-Carrasco and Y. Habibi, ACS Sustainable Chem. Eng., 2018, 6, 12603-12612.
31. R. K. Johnson, A. Zink-Sharp and W. O. Glasser, Cellulose, 2011, 18, 1599-1609.
32. L. Sun, X. Zang, H. Liu, K. Liu, H. Du, A. Kumar, G. Sharma and C. Si, Curr. Org. Chem., 2021, 25, 417-436.
33. G. Morandi, L. Heath and W. J. L. Thielenans, Langmuir, 2009, 25, 8280-8286.
34. C.-F. Huang, J.-K. Chen, T.-Y. Tsas, Y.-A. Hsieh and K.-Y. A. Lin, Polymer, 2015, 72, 395-405.
35. M. Jonoobi, J. Harn, A. P. Mathew, M. Z. B. Huwein and K. Oksnan, Celluose, 2010, 17, 299-307.
36. J. Fukuda and Y.-L. Hsich, ACS Sustainable Chem. Eng., 2021, 9, 6489-6498.
37. X. Sui, J. Yuan, M. Zhou, J. Zhang, H. Yang, W. Yuan, Y. Wei and C. Pan, Biomacromolecules, 2008, 9, 2615-2620.
38. P. Chmielarz, Express Polymer Letters, 2017, 11, 140.
39, T. Yang, P. Xiao. J. Zhang, R. Jia, H. Nawaz, Z. Chen and J. Zhang, ACS Appl. Mater. Interfaces, 2018, 11, 4302-4310.
40. X. Cao, S. Sun, X. Peng, L. Zhong. R. Sun and D. Jiang, J. Agric. Food Chem., 2013, 61, 2489-2495.
41. T. Saito, R. Kuramae, J. Woblert, L. A. Berglund and A. Isogai, Biomacromolecules, 2013, 14, 248-253.
42. P. Lu and Y.-L. Hsieh, Carbohydr. Polym., 2012, 87, 564-573.
43. L. Segal, J. J. Credy, A. Martin Jr and C. Conrad, Text. Res. J., 1959, 29, 786-794.
44. P. Scherrer, Nachr. Gr. Wiss. Göttingen, 1918, 2, 96-100.
45. K. Kowsaka, K. Okajima and K., Kamide, Polym. J., 1988, 20, 1091-1099,
46. A, Isogai, Cellulose, 1997, 4, 99-107.
47. F. Jiang, J. L. Dallas, B. K. Ahn and Y.-L. Hsieh, Carbohydr. Polym., 2014, 110, 360-366.
48. R. Nardin and M. Vincendon, Macromolecules. 1986, 19, 2452-2454.
49. J. D. Roberts and M. C. Caserio, Basic principles of organic chemistry, WA Benjamin, Inc., 1977.
50. Y. Lee, Y. Matviychuk and D. J. Holland, J. Magn. Reson., 2020, 320, 106826.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

1. A composition comprising bromine esterified nanocellulose, wherein the bromine esterified nanocellulose is at least 25% dispersible in an organic media.

2. The composition of claim 1, wherein the organic media is DMF, DMSO, chloroform, THF, toluene, or acetone.

3. (canceled)

4. The composition of claim 1, wherein the bromine esterified nanocellulose is between 1 and 6.5 nm thick, between 2 and 30 nm wide, and between 325 and 1000 nm long.

5. (canceled)

6. The composition of claim 1, wherein the bromine esterified nanocellulose has a crystallinity of at least 20%.

7. (canceled)

8. A method for producing hydrophobic bromine esterified nanocellulose, comprising:
(a) combining, in a reaction mixture, cellulose and a bromine provider in an organic media to produce bromine esterified cellulose;
(b) ultrasonicate the mixture of (a) to disintegrate the bromine esterified cellulose into bromine esterified nanocellulose,
wherein both steps (a) and (b) are performed in one container.

9. The method of claim 8, wherein the bromine provider is 2-bromopropionyl bromide (BPB) or 2-bromoisobutyryl bromide (BIB).

10. (canceled)

11. The method of claim 8, wherein the ratio of the bromine provider to anhydroglucose units (AGUs) in the cellulose is between 1:1 and 10:1 molar ratios.

12. (canceled)

13. The method of claim 8, wherein the organic media is DMF, DMSO, chloroform, THF, toluene, or acetone.

14. (canceled)

15. The method of claim 8, wherein the method is performed at a temperature of between 23° C. and 70° C.

16. (canceled)

17. The method of claim 8, wherein the ultrasonication of step (b) is performed at an amplitude of between 25% and 100%.

18. (canceled)

19. The method of claim 8, wherein the ultrasonication of step (b) is performed for a duration of between 10 minutes and 120 minutes.

20. (canceled)

21. The method of claim 8, wherein the hydrophobic bromine esterified nanocellulose is at least 25% dispersible in the organic media.

22. (canceled)

23. The method of claim 8, wherein the bromine esterified nanocellulose produced is between 1 and 6.5 nm thick, between 2 and 30 nm wide, and between 325 and 1000 nm long.

24. (canceled)

25. The method of claim 8, wherein the method produces the bromine esterified nanocellulose at a yield of at least 20%.

26. (canceled)

27. The method of claim 1, wherein the method produces the bromine esterified nanocellulose at a crystallinity of at least 20%.

28. (canceled)

29. A polyurethane produced by reacting the composition of claim 1, with 1,4-butadiol chain extender OHs or polytetramethylene ether glycol soft segment OHs.

30. (canceled)

31. A poly(lauryl methacrylate) (PLMA) produced by reacting the composition of claim 1 with lauryl methacrylate (LMA) in an organic media.

32. The PLMA of claim 31, further comprising a catalyst and a ligand.

33. The PLMA of claim 32, wherein the catalyst is a CuBr.

34. (canceled)

35. The PLMA of claim 31, wherein the organic media is DMF, DMSO, chloroform, THF, toluene, or acetone.
